(19) United States
(12) Patent Application Publication
(10) Pub. No.: US 2026/0064967 A1
(43) Pub. Date: Mar. 5, 2026

(54) PROGRAM, SLIDE ANALYSIS DEVICE, AND SLIDE ANALYSIS METHOD

(71) Applicants: Kwansei Gakuin Educational Foundation, Hyogo (JP); MICWARE CO., LTD., Hyogo (JP)

(72) Inventors: Kazutoshi SUMIYA, Hyogo (JP); Itsuki SANO, Hyogo (JP); Yukiko KAWAI, Kyoto (JP); Yuanyuan WANG, Yamaguchi (JP)

(21) Appl. No.: 19/265,302

(22) Filed: Jul. 10, 2025

(30) Foreign Application Priority Data
Aug. 29, 2024 (JP) 2024-147976

(51) Int. Cl. G06F 40/279

(52) U.S. Cl. CPC G06F 40/279

(57) ABSTRACT

A slide analysis device includes a textbook manager, a slide manager, an analyzer, and an analysis output unit. The textbook manager stores textbook information based on a textbook. The slide manager stores a slide set including two or more slides. The analyzer analyzes the slide set based on the textbook information and obtains an analysis result. The analysis output unit outputs the analysis result from the analyzer. The slide analysis device can assist in checking information on slides.

### BACKGROUND OF INVENTION

### Field of the Invention

The present invention relates to a program for analyzing a slide set and outputting analysis results.

### Background Art

Techniques have been available for generating slides based on research articles (refer to Non-Patent Literature 1). A known information processing apparatus allows lecturers to obtain, from digital devices used in lectures, operation log data about their lectures including the manners in which students read the lecture materials and their time spent on such reading, and to analyze and effectively use the operation log data (refer to Patent Literature 1).

### CITATION LIST

### Patent Literature

Patent Literature 1: WO 2020/174653

### Non Patent Literature

Non-Patent Literature 1: Tsu-Jui Fu; William Yang Wang; Daniel McDuff; Yale Song, Doc2ppt: automatic presentation slides generation from scientific documents. In Proceedings of the AAAI Conference on Artificial Intelligence, 2022, Vol. 36, pp. 634-642.

### SUMMARY OF INVENTION

However, the known techniques cannot assist in checking information on the slides.

A slide analysis device according to a first aspect of the present invention includes a textbook manager, a slide manager, an analyzer, and an analysis output unit. The textbook manager stores textbook information based on a textbook. The slide manager stores a slide set including two or more slides. The analyzer analyzes the slide set based on the textbook information and obtains an analysis result. The analysis output unit outputs the analysis result obtained by the analyzer.

This structure can assist in checking information on slides.

A slide analysis device according to a second aspect is the slide analysis device according to the first aspect in which the textbook information includes a term hierarchy structure, and the analyzer includes a term set obtainer and a reference rate analyzer. The term hierarchy structure includes two or more terms and one or more relationship identifiers each identifying a conceptual relationship between the two or more terms. The term set obtainer obtains, from each of the two or more slides in the slide set, a term set including two or more terms. The reference rate analyzer obtains, from the term hierarchy structure, a relationship identifier for the two or more terms included in the term set, and obtains, using the term set and the relationship identifier for the two or more terms, an analysis result about a reference rate for the two or more terms.

This structure can assist in checking information on the slides by analyzing the slides based on the textbook information.

A slide analysis device according to a third aspect is the slide analysis device according to the second aspect in which the one or more relationship identifiers include a part-of relationship identifier, a use-for relationship identifier, or a same-as relationship identifier. The term hierarchy structure includes a superordinate term and two or more subordinate terms associated with the part-of relationship identifier, a superordinate term and one or more subordinate terms associated with the use-for relationship identifier, or two or more terms associated with the same-as relationship identifier. The reference rate analyzer performs a part-of test, a use-for test, or a same-as test. In the part-of test, the reference rate analyzer determines whether the term set includes the superordinate term associated with the part-of relationship identifier and all the two or more subordinate terms associated with the part-of relationship identifier, and obtains, when one or more subordinate terms of the two or more subordinate terms are not included, an analysis result indicating that the one or more subordinate terms are to be added. In the use-for test, the reference rate analyzer obtains, when the term set includes the superordinate term associated with the use-for relationship identifier, a number or a ratio of subordinate terms included in the term set among the one or more terms associated with the use-for relationship identifier, and obtains, when the number or the ratio of subordinate terms is smaller than a predetermined value and satisfies an indication condition, an analysis result indicating that a subordinate term not being included in the term set is to be added. In the same-as test, the reference rate analyzer determines whether the term set includes one or more terms of the two or more terms associated with the same-as relationship identifier, and obtains, when none of the two or more terms are included, an analysis result indicating that one or more terms of the two or more terms are to be added.

This structure can obtain an analysis result about the reference rate for the slides based on the textbook information.

A slide analysis device according to a fourth aspect is the slide analysis device according to the first aspect in which the textbook information includes two or more terms and reference order information, and the analyzer includes a term set obtainer and a reference order analyzer. The reference order information identifies a reference order in which the two or more terms are referred to. The term set obtainer obtains, from each of the two or more slides in the slide set, a term set including two or more terms for which a use order in the slide is identifiable. The reference order analyzer obtains, using the term set and the reference order information, an analysis result about the reference order of the two or more terms in the term set.

This structure can obtain an analysis result about the reference order in the slides based on the textbook information.

A slide analysis device according to a fifth aspect is the slide analysis device according to the fourth aspect in which the one or more relationship identifiers include an is-a-kind-of relationship identifier. Each of two or more subordinate terms associated with the is-a-kind-of relationship identifier is associated with an order-indicative flag being an ordered flag identifying the term as being ordered or an unordered flag identifying the term as being unordered. The reference order analyzer performs an is-a-kind-of test to determine, using the reference order information, whether the term set includes a superordinate term associated with the is-a-kind-of relationship identifier and whether the term set includes two or more subordinate terms associated with the ordered flag among the two or more subordinate terms associated with the is-a-kind-of relationship identifier in an order of the two or more subordinate terms, and obtain, when the two or more subordinate terms are not included in the order, an analysis result indicating that the order is to be changed.

This structure can obtain an analysis result about the reference order in the slides based on the textbook information.

A slide analysis device according to a sixth aspect is the slide analysis device according to the first aspect in which the textbook information is an ordered term system, and the analyzer includes a term set obtainer, a reference rate analyzer, and a reference order analyzer. The ordered term system includes a term hierarchy structure and reference order information. The term hierarchy structure includes two or more terms and one or more relationship identifiers each identifying a conceptual relationship between the two or more terms. The reference order information identifies a reference order in which the two or more terms are referred to. The term set obtainer obtains, from each of the two or more slides in the slide set, a term set including two or more terms for which a use order in the slide is identifiable. The reference rate analyzer obtains, from the term hierarchy structure, a relationship identifier for the two or more terms included in the terms set, and obtains, using the term set and the relationship identifier for the two or more terms, an analysis result about a reference rate for the two or more terms. The reference order analyzer obtains, using the term set and the reference order information, an analysis result about the reference order of the two or more terms in the term set.

This structure can obtain analysis results about the reference rate for the slides and the reference order in the slides based on the textbook information.

A slide analysis device according to a seventh aspect is the slide analysis device according to the first aspect in which the analyzer includes a term set obtainer and performs a term variation test, an itemization test, a parallel relationship test, a hierarchical relationship test, a comprehensiveness test, or a conformity test. The term set obtainer obtains, from each of the two or more slides in the slide set, a term set including two or more terms. In the term variation test, the analyzer obtains an analysis result indicating a term variation when determining, using a term hierarchy structure in the textbook information, that a plurality of terms of two or more terms associated with a same-as relationship identifier are included in the term set in the slide set. In the itemization test, the analyzer obtains, from the slide set, two or more terms presented in numbered paragraphs, determines, using reference order information in the textbook information, whether a reference order of the two or more terms differs from an order of numbers corresponding to the two or more terms, and obtains, when determining that the reference order differs from the order of the numbers, an analysis result indicating an unacceptable itemization. The analyzer instead obtains an analysis result indicating an unacceptable itemization when determining, using the reference order information in the textbook information, that a term without a reference order is presented in a numbered paragraph in the slide set. In the parallel relationship test, the analyzer detects indent information of a slide in the slide set. In the parallel relationship test, the analyzer obtains an analysis result indicating an unacceptable parallel relationship when determining, using the term hierarchy structure in the textbook information, that two or more terms included in a same hierarchy in the indent information do not have a parallel relationship. In the hierarchical relationship test, the analyzer detects indent information of a slide in the slide set. In the hierarchical relationship test, the analyzer obtains two or more terms having a hierarchical relationship in the indent information and obtains an analysis result indicating an unacceptable hierarchical relationship when determining that the hierarchical relationship between the two or more terms does not match a hierarchical relationship between same two or more terms in the term hierarchy structure in the textbook information. In the comprehensiveness test, the analyzer obtains, from the term hierarchy structure in the textbook information, one or more terms subordinate to a term in the slide set, and obtains an analysis result indicating no comprehensiveness for subordinate terms when determining that at least one of the one or more subordinate terms is not used in the slide set. In the conformity test, the analyzer obtains first chapter identification information for a term used in and associated with a slide in the slide set, obtains second chapter identification information for the term from the chapter identification information in the textbook information, and obtains, when the first chapter identification information<the second chapter identification information, an analysis result indicating that a learning sequence is unconformable.

This structure allows appropriate checking of information on the slides based on the textbook information.

A slide analysis device according to an eighth aspect is the slide analysis device according to the first aspect in which the analyzer performs a text volume test to obtain a text volume of a part of or all of a slide in the slide set and obtain, when the text volume is greater than or equal to a threshold, an analysis result indicating an unacceptable text volume.

This structure can assist in providing text with an acceptable text volume for each slide.

A slide analysis device according to a ninth aspect is the slide analysis device according to the first aspect in which the analyzer performs a sentence ending form test. In the sentence ending form test, the analyzer obtains two or more sentences from each slide in the slide set, obtains a sentence ending form identifier of each of the two or more sentences, and obtains an analysis result indicating an inconsistent sentence ending form when the sentence ending form identifier of each of the two or more sentences excluding a sentence ending with a nominal differs from a predetermined sentence ending form identifier or when two or more types of sentence ending form identifiers are obtained from the two or more sentences excluding a sentence ending with a nominal.

This structure can detect an inconsistent sentence ending form in the slides.

A slide analysis device according to a tenth aspect is the slide analysis device according to any one of the first to eighth aspects further including a suggestion obtainer and a suggestion output unit. The suggestion obtainer obtains two or more correction suggestions for a slide based on the analysis result obtained by the analyzer. The suggestion output unit outputs the two or more correction suggestions. The analysis result includes information about a slide edit suggestion.

This structure can provide two or more correction suggestions for the slides.

A slide analysis device according to an eleventh aspect is the slide analysis device according to any one of the first to tenth aspects further including a corrector that corrects the slide set based on the analysis result obtained by the analyzer.

This structure can correct the slides easily.

The slide analysis device according to the above aspects of the present invention can assist in checking information on slides.

### BRIEF DESCRIPTION OF THE DRAWINGS

FIG. 1 is a block diagram of a slide analysis device 1 according to a first embodiment.

FIG. 2 is a diagram describing an example analysis performed by an analyzer 132 in the first embodiment.

FIG. 3 is a diagram describing an example analysis performed by the analyzer 132 in the first embodiment.

FIG. 4 is a flowchart of an example operation of the slide analysis device 1 according to the first embodiment.

FIG. 5 is a flowchart of an example of a term set obtaining process.

FIG. 6 is a flowchart of an example of a part-of test.

FIG. 7 is a flowchart of an example of a use-for test.

FIG. 8 is a flowchart of an example of a same-as test.

FIG. 9 is a flowchart of an example of an is-a-kind-of test.

FIG. 10 is a flowchart of an example of a term variation test.

FIG. 11 is a flowchart of an example of an itemization test.

FIG. 12 is a flowchart of an example of a parallel relationship test.

FIG. 13 is a flowchart of an example of a hierarchical relationship test.

FIG. 14 is a flowchart of an example of a comprehensiveness test.

FIG. 15 is a flowchart of an example of a conformity test.

FIG. 16 is a flowchart of an example of a text volume test.

FIG. 17 is a flowchart of an example of a sentence ending form test.

FIG. 18 is a flowchart of an example of an automatic correction process.

FIG. 19 is a flowchart of an example of a suggestion obtaining process.

FIG. 20 is a flowchart of an example of an evaluation process.

FIG. 21 is a diagram of an example term hierarchy structure.

FIG. 22 is a diagram of an example term hierarchy management table.

FIG. 23 is a diagram of an example term hierarchy structure.

FIG. 24 is a diagram showing example terms associated with one another with relationship identifiers.

FIG. 25 is a diagram of an example screen.

FIG. 26 is a diagram of an example screen.

FIG. 27 is a block diagram of a computer system.

### DETAILED DESCRIPTION

A slide analysis device and other techniques according to one or more embodiments will now be described with reference to the drawings. In the embodiments, the same reference numerals denote the same components, and such components may not be described repeatedly.

### First Embodiment

In the present embodiment, the slide analysis device analyzes a slide set based on textbook information and outputs analysis results. Examples of the analysis of the slide set include reference rate analysis and reference order analysis. Examples of the analysis of the slide set also include analysis of term variation, acceptability of itemization notation, acceptability of parallel relationship between terms, explicitness of hierarchical relationship between terms, comprehensiveness for subordinate terms, and conformity with a learning sequence. Examples of the analysis of the slide set also include analysis of an acceptable text volume on each slide.

In the present embodiment, the slide analysis device outputs edit suggestions for the slide.

In the present embodiment, the slide analysis device automatically corrects the slide.

Information X being associated with information Y herein refers to the information X associated with the information Y in any manner that allows the information Y to be obtained from the information X and the information X to be obtained from the information Y. For example, the information X and the information Y may be linked to each other or be in the same buffer. The information Y may include the information X, or the information X may include the information Y.

Selecting or determining information Z herein refers to accessing the information Z in any manner, and includes obtaining the information Z, obtaining a pointer to the information Z, obtaining an identification (ID) of the information Z, and flagging the information Z.

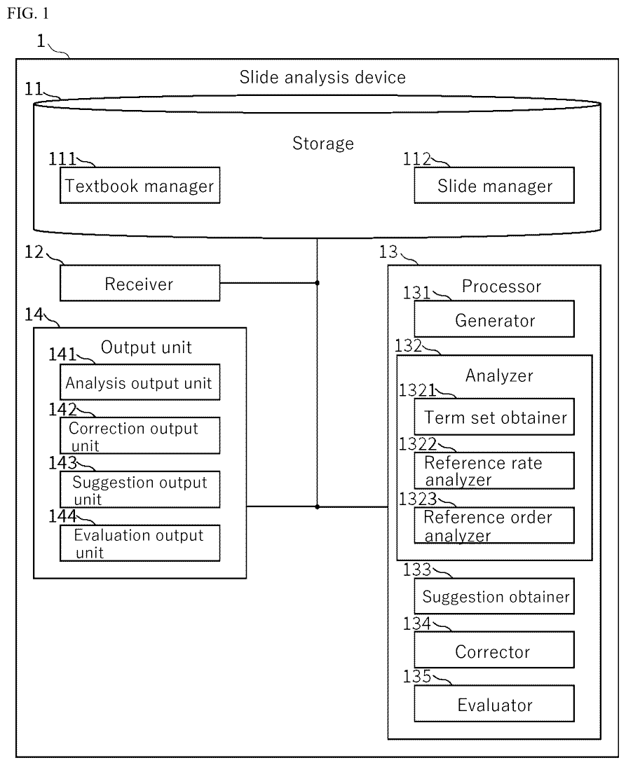

FIG. 1 is a block diagram of a slide analysis device 1 according to the present embodiment. The slide analysis device 1 analyzes a slide set. The slide analysis device 1 is, for example, a terminal, but may be a server. The slide analysis device 1 being a terminal may be, for example, a personal computer (PC), a smartphone, or a tablet terminal of any type. The slide analysis device 1 being a server may be, for example, a cloud server or an application service provider (ASP) of any type.

The slide analysis device 1 includes a storage 11, a receiver 12, a processor 13, and an output unit 14. The storage 11 includes a textbook manager 111 and a slide manager 112. The processor 13 includes a generator 131, an analyzer 132, a suggestion obtainer 133, a corrector 134, and an evaluator 135. The analyzer 132 includes a term set obtainer 1321, a reference rate analyzer 1322, and a reference order analyzer 1323. The output unit 14 includes an analysis output unit 141, a correction output unit 142, a suggestion output unit 143, and an evaluation output unit 144.

The storage 11 stores various information items. Examples of the various information items include textbook information (described later), the slide set (described later), and a textbook.

The textbook refers to a textbook used in a lecture. The lecture includes, for example, an explanation, a comment, and other wide range of concepts. The textbook is information on which the lecture is based. Examples of the textbook are not limited to commercially available textbooks. The textbook includes a reference book, a curriculum guidance, a research article, and other wide range of items.

The textbook manager 111 stores the textbook information. The textbook information is based on the textbook. The textbook information includes, for example, a term hierarchy structure. The textbook information includes, for example, reference order information. The textbook information includes, for example, chapter identification information. The textbook information is, for example, an ordered term system. The ordered term system includes the term hierarchy structure and the reference order information.

The term hierarchy structure is information including one or more relationship identifiers each identifying the conceptual relationship between two or more terms. The term hierarchy structure typically includes two or more terms. Each of the terms is typically a single word, but may be two or more words. In other words, the term may be a phrase. The terms in this example are terms used in the textbook.

Examples of the relationship identifiers include is-a, part-of, use-for, same-as, is-a-kind-of, refer-to, and is-an-example-of.

An is-a relationship is the relationship between a term for a subordinate concept and a term for a superordinate concept. An example of the is-a relationship is “quick sort” is-a “large data alignment.”

A part-of relationship is the relationship between a term indicating a whole and a term indicating a part of the whole. An example of the part-if relationship is “bucket” part-of “bucket sort.”

A use-for relationship is, among relationships between a whole and a part, a conceptual relationship indicating a purpose of use. Examples of the use-for relationships are “queue” use-for “job management” and “queue” use-for “message handler,” with “queue” used to perform “job management” for a printer or “message handler” for a window system.

A same-as relationship is the relationship between two or more terms with the same meaning. The same meaning in this example refers to a relationship in which the terms are interchangeably used for the same meaning. An example of the same-as relationship is “queue” same-as “line,” with “queue” also referred to as “line.” In this example, terms that have different meanings under a strict definition may have the same-as relationship when used as terms with the same meaning in the textbook used for construction.

An is-a-kind-of relationship is, among relationships between a superordinate and a subordinate, a conceptual relationship indicating a type. The type in this example refers to a group of concepts classified based on common properties. Examples of the is-a-kind-of relationship are “stack” is-a-kind-of “data structure” and “queue” is-a-kind-of “data structure.”

A refer-to relationship is a conceptual relationship indicating a reference origin and a reference destination. For example, when “array” used in the fourth chapter of the textbook has already been referred to in the third chapter, the relationship is described as “array (the fourth chapter)” refer-to “array (the third chapter).”

An is-an-example-of relationship is, among relationships between a superordinate and a subordinate, a conceptual relationship indicating an example. The example in this example refers to an object replacing another object with the same properties. For example, with “one-way tunnel” and “order sheet holder” having the properties of “queue,” the relationships are described as “tunnel” is-an-example-of “queue” and “order sheet holder” is-an-example-of “queue.”

The reference order information identifies the order in which two or more terms are referred to. The reference order information typically includes two or more terms. The reference order information is, for example, a set of two or more terms arranged in the order of reference. The reference order information includes, for example, order identifiers (e.g., numbers indicating the order) each associated with one of the two or more terms. The reference order information may be any information identifying the reference order of the two or more terms and may have any data structure.

The reference order information includes, for example, an order-indicative flag for the two or more terms. The order-indicative flag indicates whether two or more subordinate terms are ordered. The order-indicative flag may be an ordered flag or an unordered flag. For example, two or more subordinate terms associated with the is-a-kind-of relationship identifier may be associated with the order-indicative flag.

The ordered term system is information including the term hierarchy structure and the reference order information. In other words, the reference order information may be embedded in the term hierarchy structure.

One or both of the term hierarchy structure and the reference order information may include two or more terms.

The slide manager 112 stores the slide set including two or more slides. Each of the two or more slides included in the slide set is associated with the chapter identification information. The slide set in the slide manager 112 may be generated by the generator 131, or may be created manually.

The chapter identification information can identify a chapter of the textbook in which a term is used. The chapter identification information is, for example, a chapter identifier associated with the term. The chapter identifier is information identifying the chapter. The chapter identifier is, for example, 1 or the first chapter. The chapter identification information is, for example, one or more terms that are associated with two or more chapter identifiers. Each of the two or more terms included in the term hierarchy structure or the reference order information may be associated with the chapter identification information.

The receiver 12 receives various instructions and information items. The various instructions and information items include, for example, an analysis instruction. The analysis instruction is an instruction to analyze the slide set. Receiving the various instructions and information items in this example includes, for example, receiving information input from an input device such as a keyboard, a mouse, or a touchscreen, but may also include receiving information transmitted through a wired or wireless communication line, and receiving information read from a recording medium such as an optical disc, a magnetic disk, or a semiconductor memory.

The various instructions and information items may be input with any input unit including, for example, a touchscreen, a keyboard, a mouse, or a menu screen.

The processor 13 performs various processes. The various processes include processes performed by the generator 131, the analyzer 132, the suggestion obtainer 133, or the corrector 134.

The generator 131 generates, based on the textbook, the slide set explaining the contents of the textbook. The generator 131 may be implemented with a known technique such as a technique described in Non-Patent Literature 1. The known technique for the generator 131 will not be described in detail.

The analyzer 132 analyzes the slide set based on the textbook information and obtains analysis results. Examples of the analysis performed by the analyzer 132 include a term variation test, an itemization test, a parallel relationship test, a hierarchical relationship test, a comprehensiveness test, a conformity test, a text volume test, and a sentence ending form test.

### (1) Term Variation Test

The analyzer 132 obtains two or more terms associated with the same-as relationship identifier in the term hierarchy structure included in the textbook information. When determining that the slide set includes multiple terms of the two or more terms, the analyzer 132 obtains an analysis result indicating the multiple terms as a term variation.

The analyzer 132 may not determine the multiple terms as a term variation when the multiple terms are simply used in a single sentence in the slide set. An example of the multiple terms in a single sentence is, for example, “bubble sort.”

### (2) Itemization Test

The analyzer 132 obtains, from the slide set, two or more terms presented in numbered paragraphs. The analyzer 132 determines whether the reference order of the terms indicated in the reference order information in the textbook information differs from the order of the numbers corresponding to the two or more terms. When the reference order differs from the order of the numbers, the analyzer 132 obtains an analysis result indicating an unacceptable itemization.

When determining, using the reference order information included in the textbook information, that a term with no reference order is presented in a numbered paragraph, the analyzer 132 obtains an analysis result indicating an unacceptable itemization.

### (3) Parallel Relationship Test

The analyzer 132 detects indent information from each slide included in the slide set. The analyzer 132 then obtains two or more terms on the same level in the indent information. When determining, using the term hierarchy structure included in the textbook information, that the two or more terms do not have a parallel relationship in the term hierarchy structure, the analyzer 132 obtains an analysis result indicating that the two or more terms have an unacceptable parallel relationship.

### (4) Hierarchical Relationship Test

The analyzer 132 detects the indent information of each slide included in the slide set. The analyzer 132 obtains two or more terms having a hierarchical relationship in the indent information. When determining that the hierarchical relationship between the two or more terms is not identical to the hierarchical relationship between the same two or more terms in the term hierarchy structure, the analyzer 132 obtains an analysis result indicating an unacceptable hierarchical relationship.

### (5) Comprehensiveness Test

The analyzer 132 obtains a term included in the slide set and refers to the term hierarchy structure to obtain one or more terms that are subordinate concepts to the term. The analyzer 132 then determines whether the one or more subordinate terms are used in the slide set. When determining that any of the one or more subordinate terms are not used in the slide set, the analyzer 132 obtains an analysis result indicating no comprehensiveness for subordinate terms.

### (6) Conformity Test

The analyzer 132 obtains first chapter identification information for a term used in and associated with a slide in the slide set. The analyzer 132 also obtains second chapter identification information for the term from the chapter identification information in the textbook information. When the first chapter identification information<the second chap identification information, the analyzer 132 obtains an analysis result indicating that the learning sequence is unconformable. In other words, when the term is used in an earlier chapter in the slide set than in the textbook, the analyzer 132 obtains an analysis result indicating that the slide set is unconformable.

### (7) Text Volume Test

The analyzer 132 obtains the text volume of a part of or all of a slide in the slide set and obtains, when the text volume is greater than or equal to a threshold, an analysis result indicating an unacceptable text volume. The threshold is, for example, a specific number of characters (e.g., 20 characters) or a specific number of rows (e.g., 3 rows). A part of or all of the slide is referred to as a text volume test unit. The text volume test unit is used for a text volume test. Examples of the text volume test unit include a slide set, a single slide, a text area (e.g., a single text box), a sentence, and an item in an itemization.

### (8) Sentence Ending Form Test

The analyzer 132 obtains two or more sentences from each slide included in the slide set. The analyzer 132 then obtains a sentence ending form identifier of each of the two or more sentences. The sentence ending form identifier is information identifying the form of a sentence ending expression. Examples of the sentence ending form identifier include a plain form and a polite form. When the obtained sentence ending form identifier is different from a predetermined sentence ending form identifier or when two or more types of sentence ending form identifiers are obtained, the analyzer 132 obtains an analysis result indicating an inconsistent sentence ending form. The analyzer 132 does not analyze a sentence ending with a nominal in the sentence ending form test.

The term set obtainer 1321 obtains, from each of the two or more slides included in the slide set, a term set including two or more terms.

For example, the term set obtainer 1321 obtains, from each of the two or more slides included in the slide set, a term set including two or more terms for which the order of use in the slide is identifiable.

The term set obtainer 1321 obtains one or more terms from each of the two or more slides included in the slide set. The term set obtainer 1321 may obtain one or more terms used in a slide in the slide set and included in the term hierarchy structure. In other words, each of the two or more terms included in the term set obtained by the term set obtainer 1321 is typically a term included in the textbook information.

The reference rate analyzer 1322 obtains, from the textbook information, the relationship identifiers of the two or more terms in the term set obtained by the term set obtainer 1321, and uses the term set and the relationship identifiers of the two or more terms to obtain an analysis result indicating the rates of reference to the two or more terms. The rates of reference to the two or more terms may be referred to as the rate of reference to the slide set. The rates of reference to the two or more terms may be referred to as, for example, the rate of reference to the textbook.

The reference rate analyzer 1322 performs, for example, a part-of test, a use-for test, or a same-as test.

### (1) Part-of Test

For example, the reference rate analyzer 1322 determines whether the term set obtained by the term set obtainer 1321 includes one superordinate term associated with the part-of relationship identifier and all two or more subordinate terms associated with the part-of relationship identifier. When one or more of the two or more subordinate terms are not included, the reference rate analyzer 1322 obtains an analysis result indicating that the one or more subordinate terms not included are to be added. The superordinate term is a term superordinate among two or more terms having a hierarchical relationship. The subordinate terms are terms subordinate among the two or more terms having the hierarchical relationship. The analysis result may include a subordinate term not included.

### (2) Use-for Test

For example, when one superordinate term associated with the use-for relationship identifier is included in the term set obtained by the term set obtainer 1321, the reference rate analyzer 1322 obtains the number or ratio of subordinate terms included in the term set among two or more subordinate terms associated with the use-for relationship identifier. When the number or ratio is sufficiently small to satisfy an indication condition, the reference rate analyzer 1322 obtains an analysis result indicating that a subordinate term not included is to be added. The indication condition is, for example, less than or equal to 1, or less than 50%. The analysis result may include a subordinate term not included.

### (3) Same-as Test

For example, the reference rate analyzer 1322 determines whether one or more of two or more terms associated with the same-as relationship identifier are included in the term set obtained by the term set obtainer 1321. When none of the two or more terms are included, the reference rate analyzer 1322 obtains an analysis result indicating that the one or more of the two or more terms are to be added. The analysis result may include one or more of the two or more terms not included. The analysis result may include the one or more terms.

The reference order analyzer 1323 uses the term set obtained by the term set obtainer 1321 and the reference order information to obtain an analysis result about the order of reference to the two or more terms included in the term set. The analysis result may include the two or more terms.

The reference order analyzer 1323 performs, for example, an is-a-kind-of test described below. Specifically, the reference order analyzer 1323 determines, using the reference order information, whether the term set obtained by the term set obtainer 1321 includes a single superordinate term associated with the is-a-kind-of relationship identifier and includes, among the two or more subordinate terms associated with the is-a-kind-of relationship identifier, two or more subordinate terms associated with the ordered flag in the order of the two or more subordinate terms. When the two or more subordinate terms included in the slide set are not in the order of the two or more subordinate terms, the reference order analyzer 1323 obtains an analysis result indicating that the order of the two or more subordinate terms is to be changed. The term set in this example is information in which the use order of two or more terms is identifiable. For a term, whether the term set includes the term is whether the slide set includes the term.

When a single superordinate and two or more subordinate terms associated with the is-a-kind-of relationship identifier are included in the term hierarchy structure, the two or more subordinate terms may be associated with the ordered flag or the unordered flag. The two or more subordinate terms associated with the ordered flag is, for example, managed in the term hierarchy structure in a manner in which the order of the terms is identifiable.

The suggestion obtainer 133 obtains two or more correction suggestions for a single slide based on the analysis results from the analyzer 132.

For example, when the analyzer 132 obtains the analysis result indicating an unacceptable text volume in the text volume test described above, the suggestion obtainer 133 generates a first suggestion to divide a text with the unacceptable text volume and a second suggestion to summarize the text with the unacceptable text volume. The suggestion output unit 143 then outputs the first suggestion and the second suggestion to a user. The corrector 134 replaces the text with the unacceptable text volume with a suggestion selected by the user.

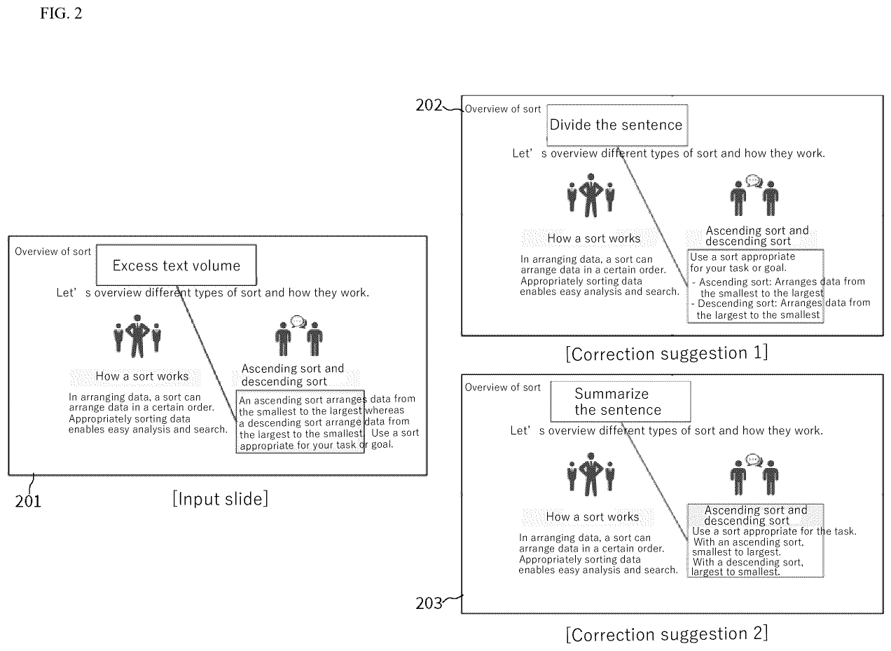

An example is shown in FIG. 2. In FIG. 2, the analyzer 132 performs the text volume test on an input slide 201. The suggestion obtainer 133 generates and outputs a first suggestion 202 to divide a text with an excess text volume and a second suggestion to summarize the text with an excess text volume. The corrector 134 then replaces the text with an excess text volume with a suggestion selected by the user. The correction output unit 142 outputs the slide corrected by the corrector 134.

The corrector 134 corrects the slide set based on the analysis results from the analyzer 132. For example, when the analyzer 132 detects a term variation, the corrector 134 obtains the use count of each of two or more terms associated with the term variation in the slide set, determines a term with the largest use count, and replaces the other terms with the determined term.

The corrector 134 may output, to the user, the two or more terms associated with the term variation, and replace, with a term selected by the user, the other terms.

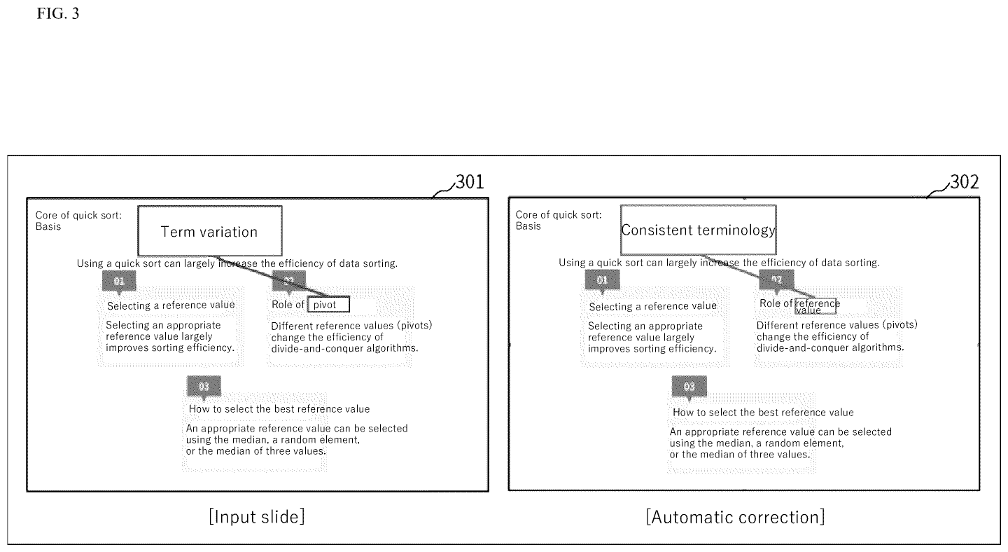

An example is shown in FIG. 3. In FIG. 3, the corrector 134 obtains two terms “reference value” and “pivot” associated with the term variation, obtains the use counts of the terms in the slide set, determines the term “reference value” as having the largest use count, and replaces the other term “pivot” with the determined term “reference value.”

The evaluator 135 evaluates the slide set based on the analysis results obtained by the analyzer 132 and obtains an evaluation value. The evaluator 135 obtains, for example, the evaluation value for each analysis. For example, the evaluator 135 obtains a lower evaluation value for an analysis when a larger number of items is determined unacceptable (FAIL) based on the analysis.

For example, the evaluator 135 obtains an overall evaluation value of the slide set using the evaluation value for each analysis. The evaluator 135 obtains a higher overall evaluation value when the evaluation value for each analysis is higher.

The output unit 14 outputs various information items. Examples of the various information items include the analysis results, two or more correction suggestions, and the modified slide set.

Outputting the various information items in this example includes displaying them on a display, projecting them with a projector, printing them with a printer, outputting them as sound, transmitting them to an external device, storing them into a recording medium, and transferring a processing result to another processing device or another program.

The analysis output unit 141 outputs the analysis results obtained by the analyzer 132.

The correction output unit 142 outputs slides corrected by the corrector 134.

The suggestion output unit 143 outputs the two or more correction suggestions obtained by the suggestion obtainer 133.

The evaluation output unit 144 outputs the evaluation value obtained by the evaluator 135. For example, the evaluation output unit 144 outputs the overall evaluation value obtained by the evaluator 135.

Each of the storage 11, the textbook manager 111, and the slide manager 112 may be a nonvolatile recording medium, but may be a volatile recording medium.

The storage 11 or other components store the information items through any processes. For example, the storage 11 or other components may store the information items through a recording medium, through a communication line transmitting the information items, or through an input device with which the information items are input.

The receiver 12 may be implemented by, for example, a device driver for an input unit such as a touchscreen or a keyboard, or control software for a menu screen. The receiver 12 may also be implemented by a wireless or wired communicator.

The processor 13, the generator 131, the analyzer 132, the suggestion obtainer 133, the corrector 134, the evaluator 135, the term set obtainer 1321, the reference rate analyzer 1322, and the reference order analyzer 1323 are typically implemented by a processor or a memory.

The processing procedures performed by the processor 13 and other components are typically implemented by software that is recorded in a recording medium such as a read-only memory (ROM). However, the processing procedures may be implemented by hardware (a dedicated circuit). The processor may be a central processing unit (CPU), a microprocessing unit (MPU), or a graphics processing unit (GPU) of any type.

The output unit 14, the analysis output unit 141, the correction output unit 142, the suggestion output unit 143, and the evaluation output unit 144 may or may not include an output device such as a display or a speaker. The output unit 14 may be implemented by, for example, driver software for an output device, or by driver software for an output device and the output device. The output unit 14 and other components may be implemented by a wireless or wired communicator.

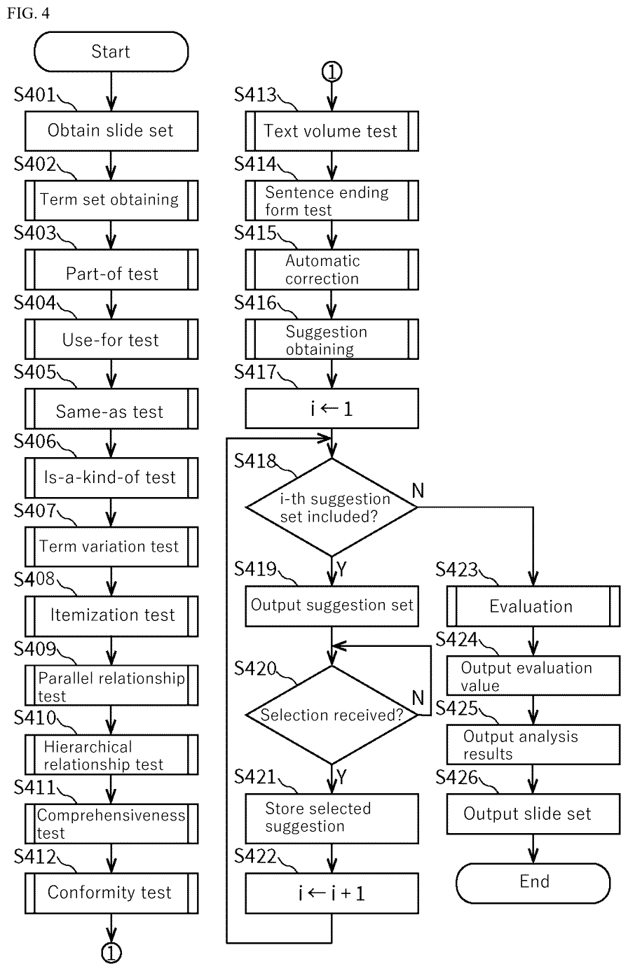

An operation example of the slide analysis device 1 will now be described with reference to the flowchart in FIG. 4.

(Step S401) The analyzer 132 obtains a slide set from the slide manager 112. The slide set is a set of slides to be analyzed.

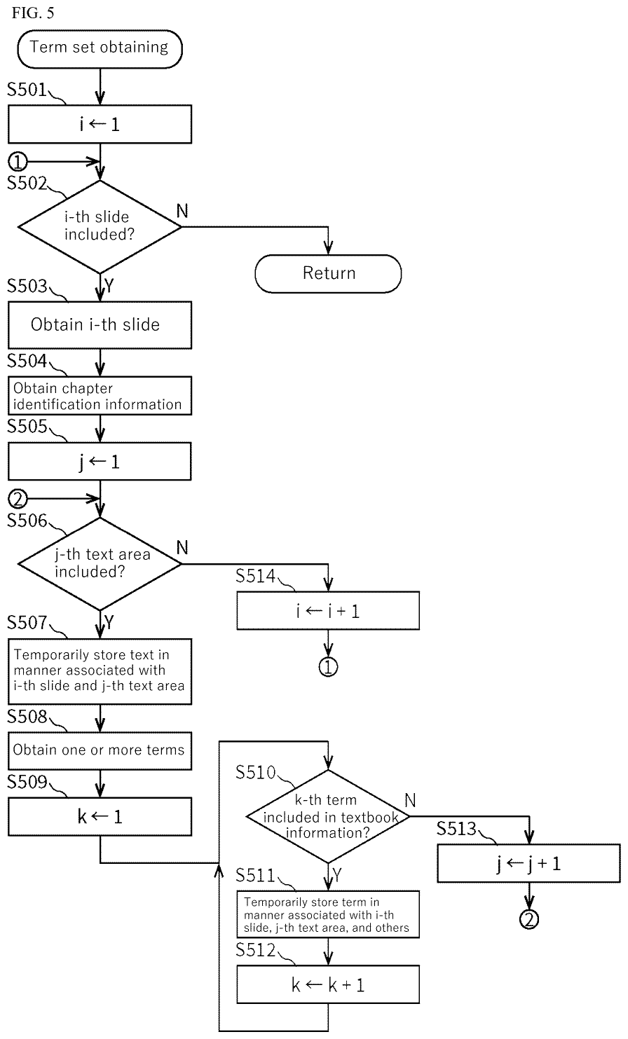

(Step S402) The term set obtainer 1321 performs a process of obtaining term sets from the slide set. An example of the term set obtaining process will be described with reference to the flowchart in FIG. 5.

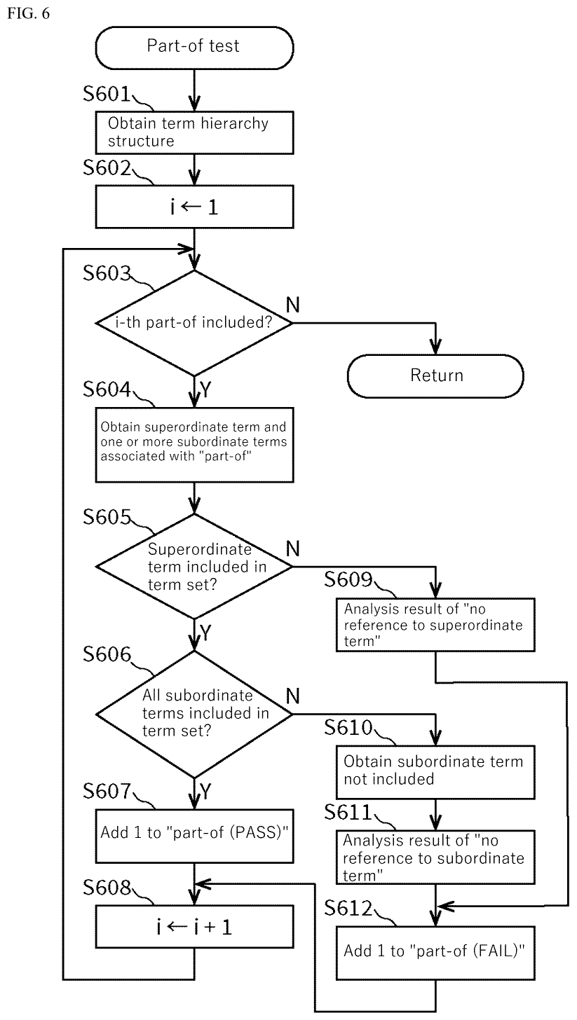

(Step S403) The analyzer 132 performs a test on the slide set using the part-of relationship identifier. An example of the part-of test will be described with reference to the flowchart in FIG. 6.

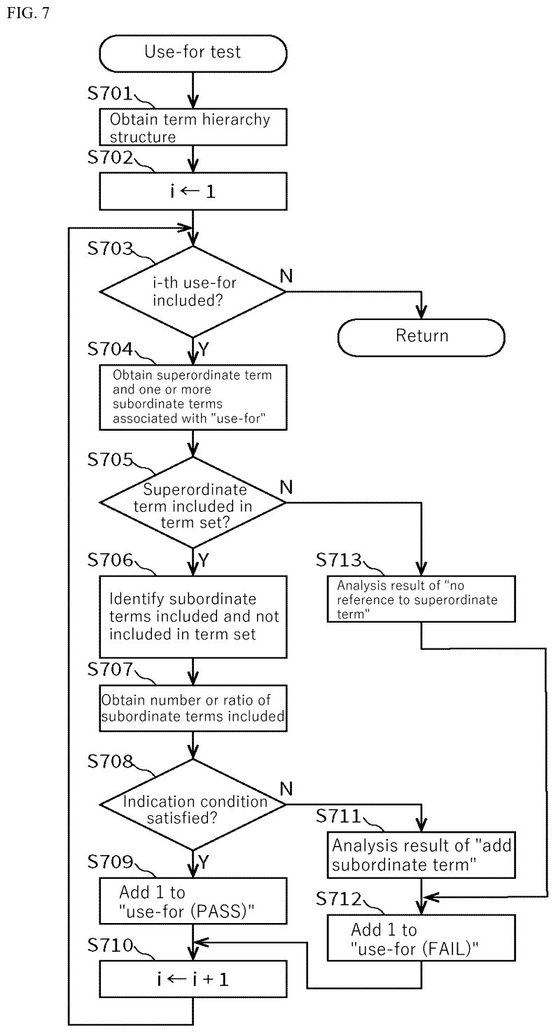

(Step S404) The analyzer 132 performs a test on the slide set using the use-for relationship identifier. An example of the use-for test will be described with reference to the flowchart in FIG. 7.

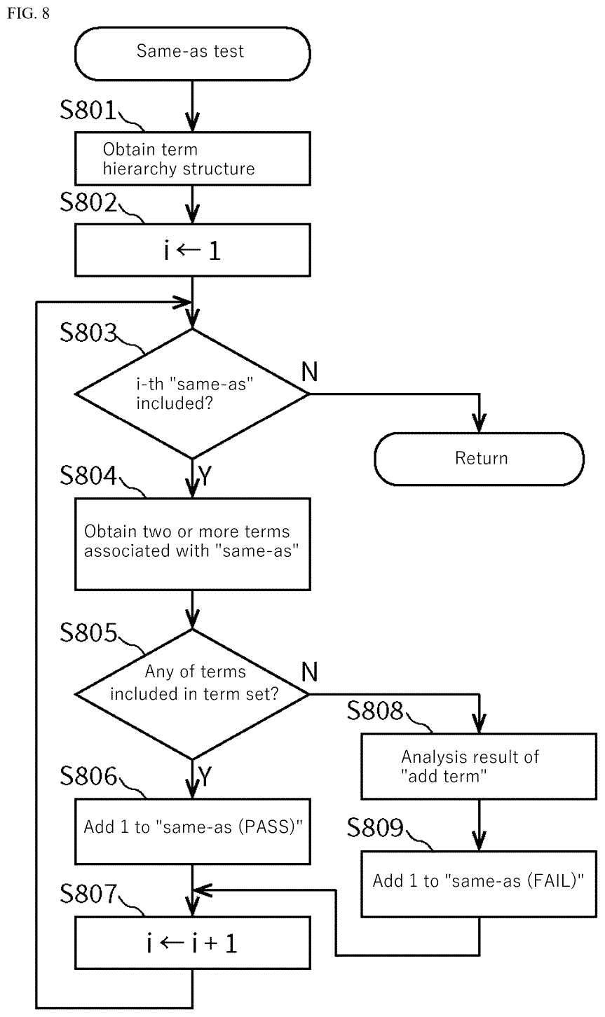

(Step S405) The analyzer 132 performs a test on the slide set using the same-as relationship identifier. An example of the same-as test will be described with reference to the flowchart in FIG. 8.

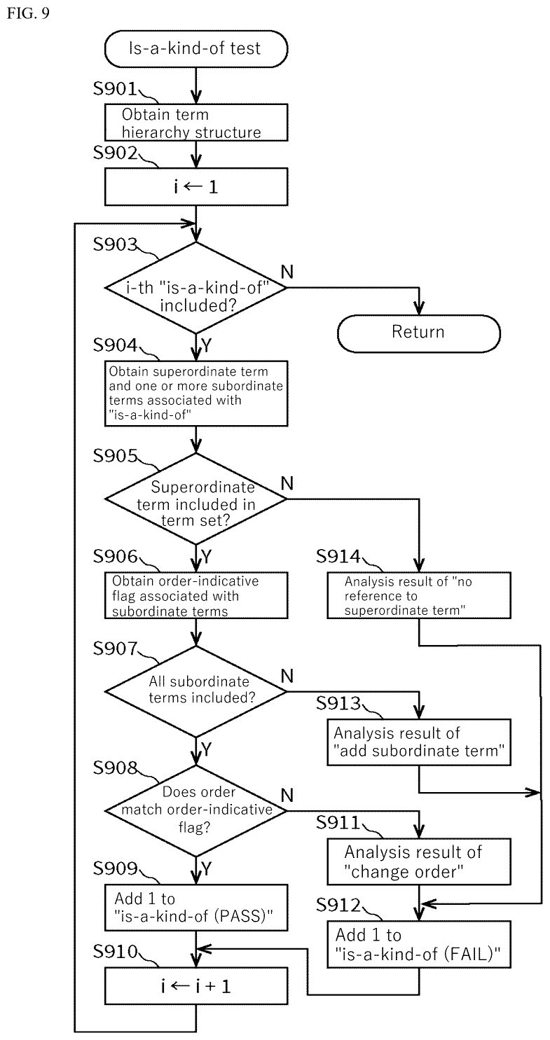

(Step S406) The analyzer 132 performs a test on the slide set using the is-a-kind-of relationship identifier. An example of the is-a-kind-of test will be described with reference to the flowchart in FIG. 9.

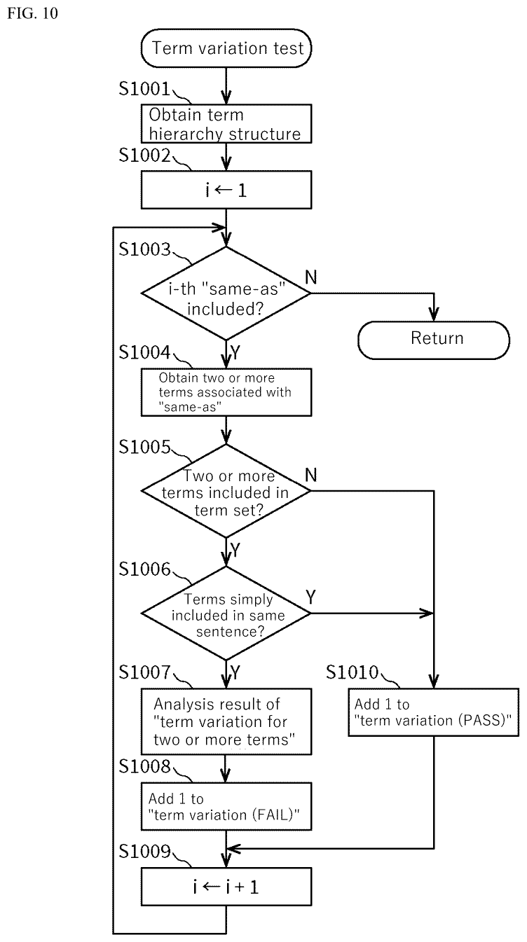

(Step S407) The analyzer 132 performs a test for term variation. An example of the term variation test will be described with reference to the flowchart in FIG. 10.

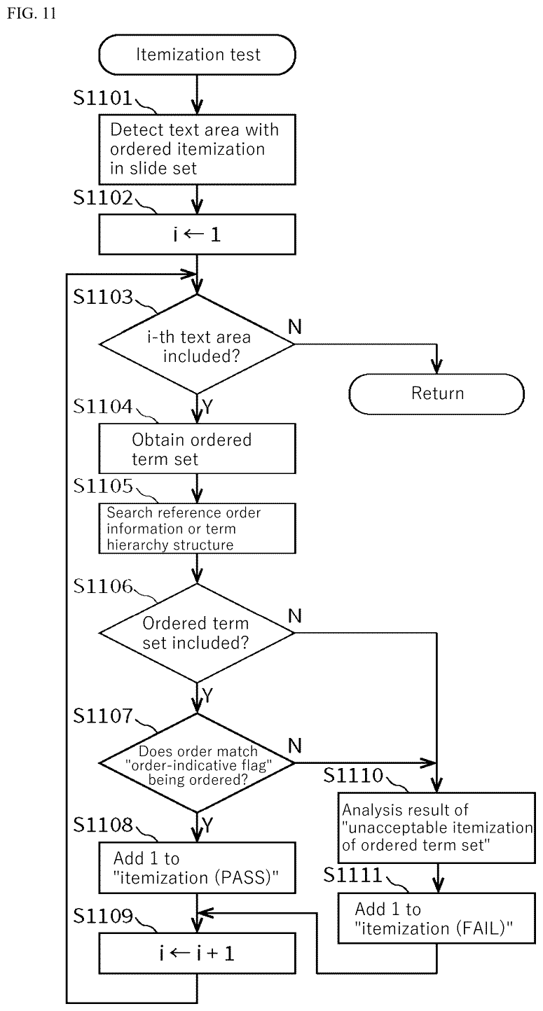

(Step S408) The analyzer 132 performs a test for itemization. An example of the itemization test will be described with reference to the flowchart in FIG. 11.

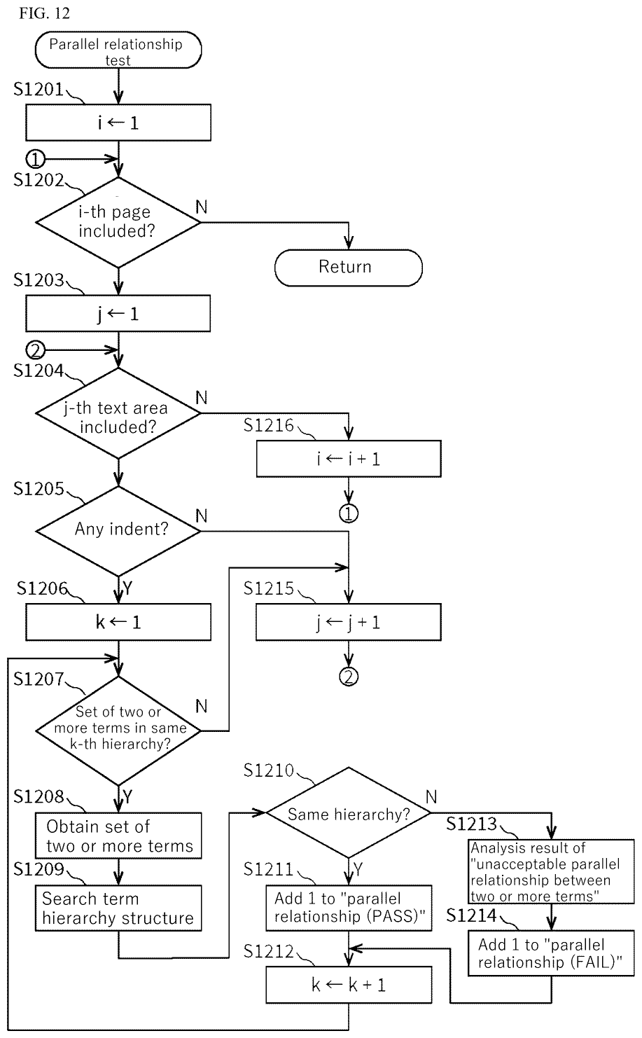

(Step S409) The analyzer 132 performs a test for parallel relationship. An example of the parallel relationship test will be described with reference to the flowchart in FIG. 12.

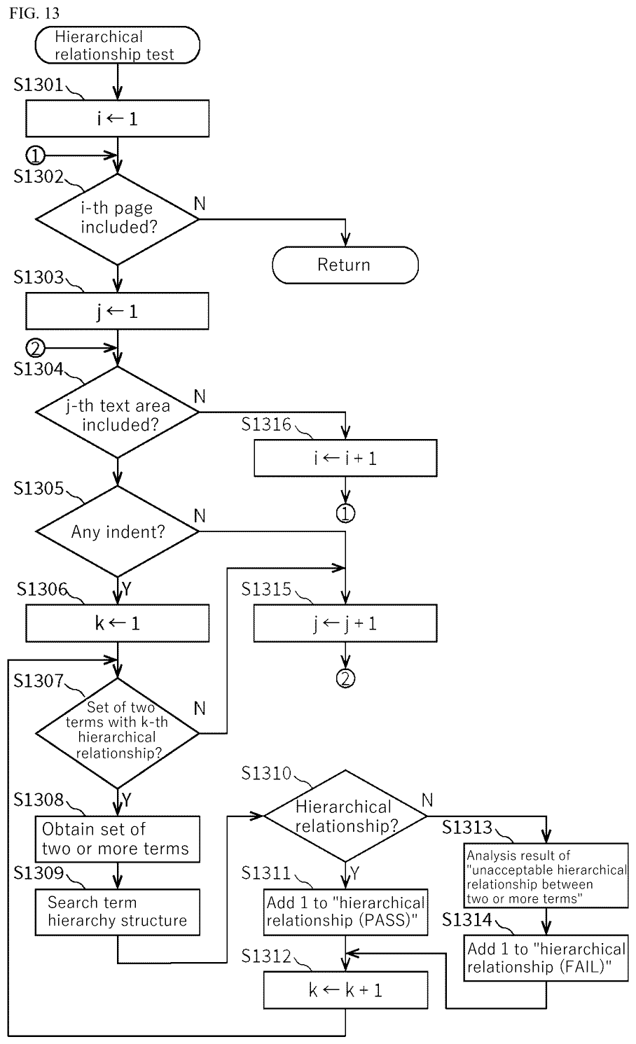

(Step S410) The analyzer 132 performs a test for hierarchical relationship between terms. An example of the hierarchical relationship test will be described with reference to the flowchart in FIG. 13.

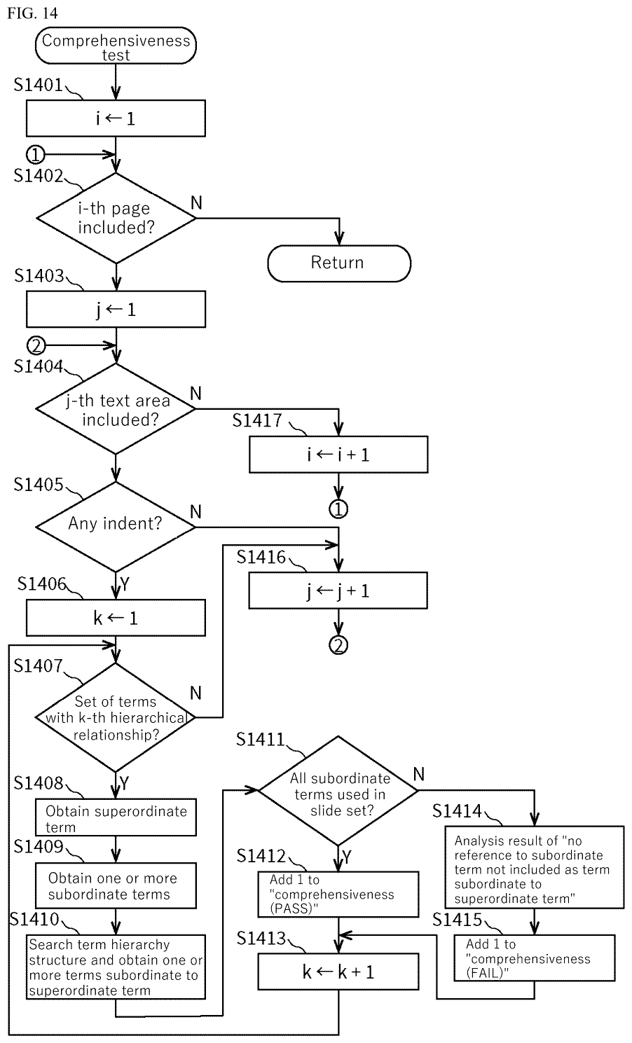

(step S411) The analyzer 132 performs a test for comprehensiveness for terms. An example of the comprehensiveness test will be described with reference to the flowchart in FIG. 14.

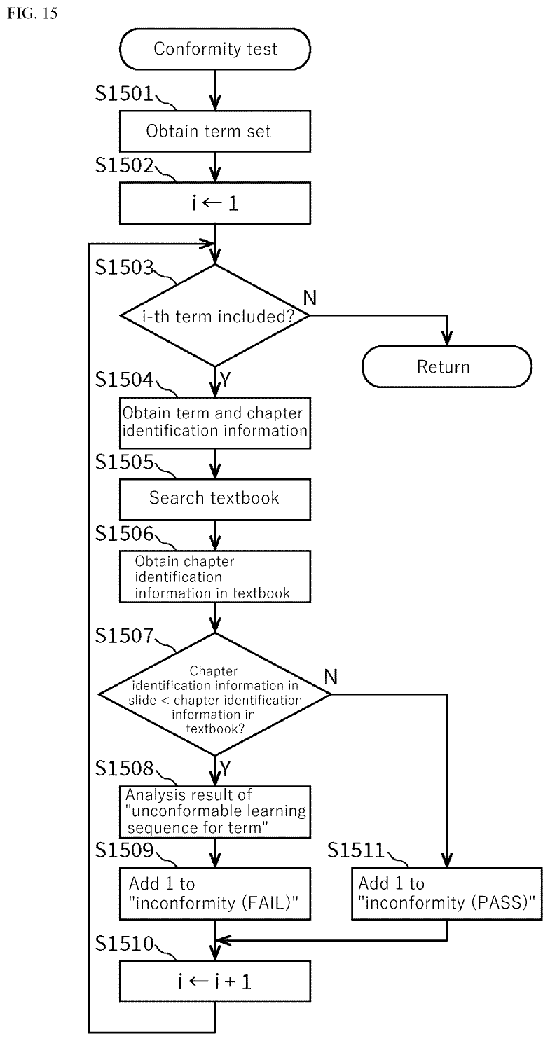

(step S412) The analyzer 132 performs a test for conformity with the learning sequence of terms. An example of the conformity test will be described with reference to the flowchart in FIG. 15.

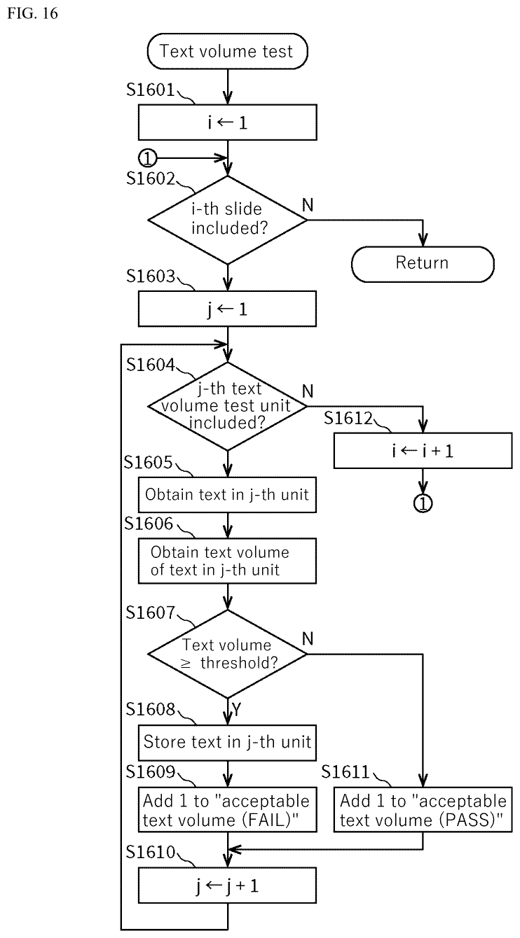

(Step S413) The analyzer 132 performs the text volume test for text volumes. An example of the text volume test will be described with reference to the flowchart in FIG. 16.

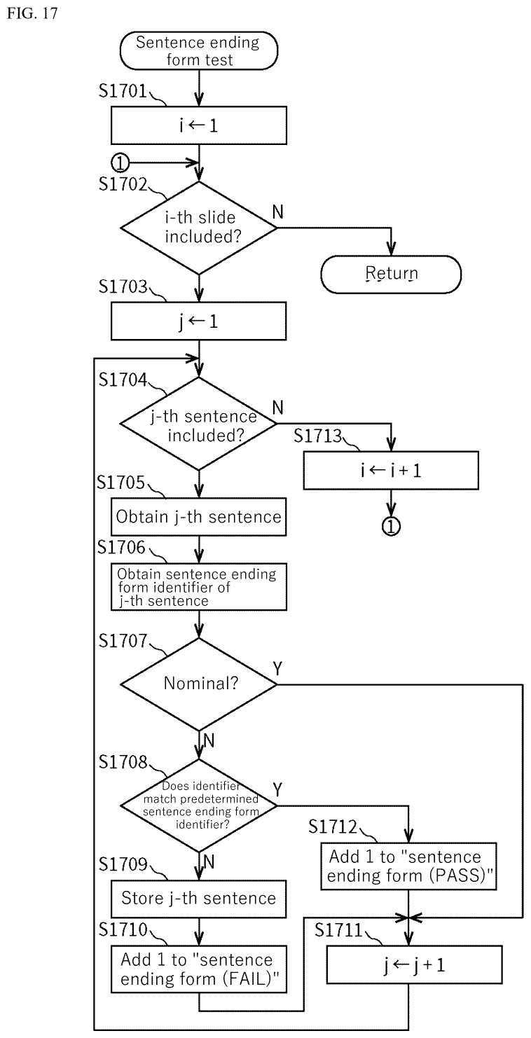

(Step S414) The analyzer 132 performs the sentence ending form test for sentence ending form. An example of the sentence ending form test will be described with reference to the flowchart in FIG. 17.

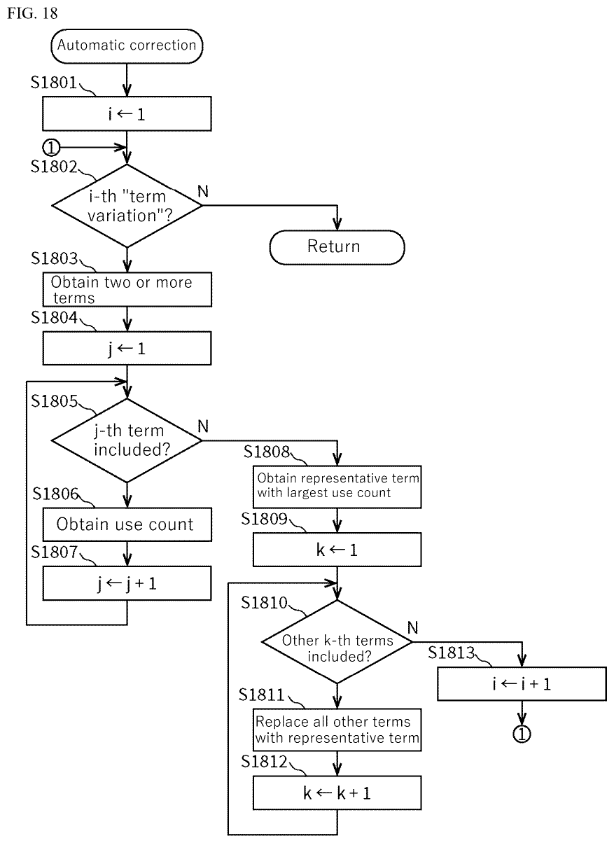

(Step S415) The corrector 134 corrects the slide set automatically. An example of the automatic correction process will be described with reference to the flowchart in FIG. 18.

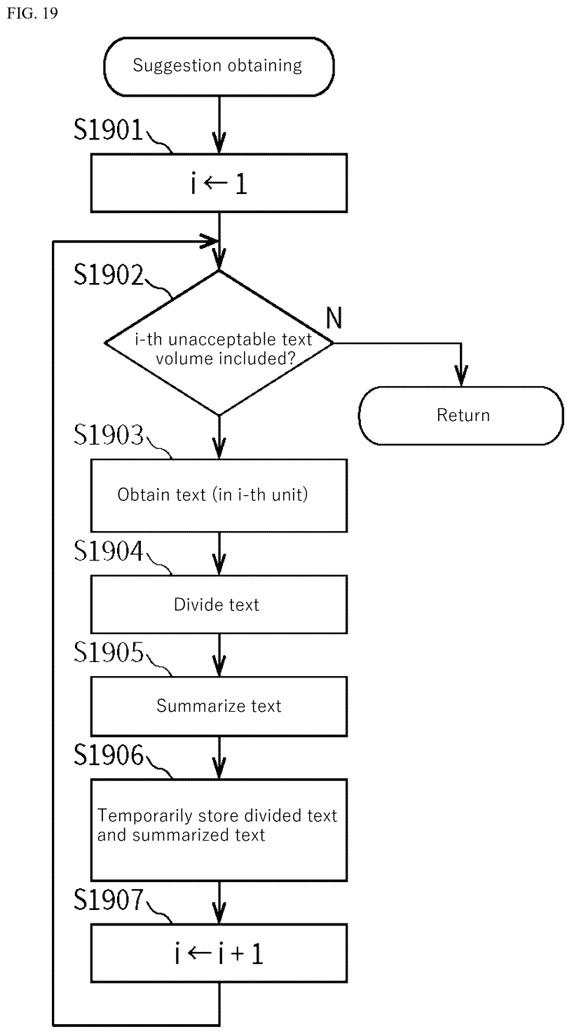

(step S416) The suggestion obtainer 133 temporarily stores correction suggestions for a sentence to be corrected. An example of the suggestion obtaining process will be described with reference to the flowchart in FIG. 19.

(Step S417) The corrector 134 substitutes 1 into a counter i.

(Step S418) The corrector 134 determines whether an i-th set of correction suggestions is included in a buffer (not shown). When the i-th set of correction suggestions is included, the processing advances to step S419. When the i-th set of correction suggestions is not included, the processing advances to step S423.

(Step S419) The suggestion output unit 143 outputs the i-th set of correction suggestions to the user.

(Step S420) The receiver 12 determines whether a correction suggestion has been selected by the user. When a correction suggestion has been selected, the processing advances to step S421. When no correction suggestion has been selected, the processing returns to step S420.

(Step S421) The corrector 134 replaces a sentence associated with the i-th set of correction suggestions with the correction suggestion selected by the user.

(Step S422) The corrector 134 increments the counter i by 1. The processing returns to step S418.

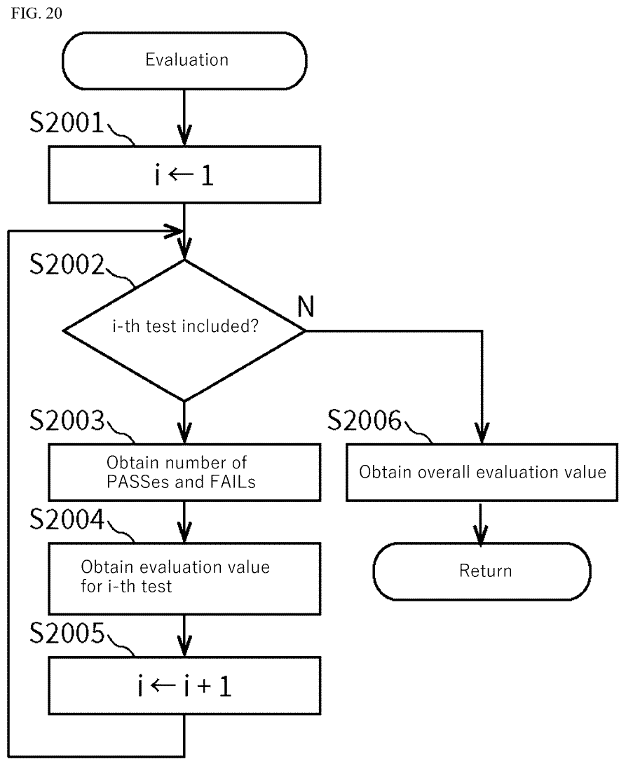

(Step S423) The evaluator 135 evaluates the slide set and obtains the evaluation value. An example of the evaluation process will be described with reference to the flowchart in FIG. 20.

(Step S424) The evaluation output unit 144 outputs the evaluation value obtained in step S422.

(Step S425) The analysis output unit 141 outputs the analysis results for the slide set.

(Step S426) The output unit 14 outputs the corrected slide set. The processing ends.

The example of the term set obtaining process in step S402 will now be described with reference to the flowchart in FIG. 5.

(Step S501) The term set obtainer 1321 substitutes 1 into the counter i.

(Step S502) The term set obtainer 1321 determines whether an i-th slide (page) is included in the slide set. When the i-th slide is included, the processing advances to step S503. When the i-th slide is not included, the processing returns to the superordinate process.

(Step S503) The term set obtainer 1321 obtains the i-th slide.

(Step S504) The term set obtainer 1321 obtains the chapter identification information associated with the i-th slide.

(Step S505) The term set obtainer 1321 substitutes 1 into a counter j.

(Step S506) The term set obtainer 1321 determines whether the j-th text area is included in the i-th slide. When the j-th text area is included, the processing advances to step S507. When the j-th text area is not included, the processing advances to step S514. The text area is an area in which text can be obtained. The text area is, for example, a text box, but may be an image including text.

(Step S507) The term set obtainer 1321 temporarily stores the text from the text area in a manner associated with the i-th slide and the j-th text area. The term set obtainer 1321 may perform a character recognition process on the image to obtain the text.

(Step S508) The term set obtainer 1321 obtains one or more terms from the text area. For example, the term set obtainer 1321 performs a morphological analysis on the text to obtain one or more independent terms.

(Step S509) The term set obtainer 1321 substitutes 1 into a counter k.

(Step S510) The term set obtainer 1321 determines whether a k-th term is included in the terms obtained in step S508. When the k-th term is included, the processing advances to step S511. When the k-th term is not included, the processing advances to step S513.

(Step S511) The term set obtainer 1321 temporarily stores the k-th term into the buffer (not shown) in a manner associated with the i-th slide, the j-th text area, and other information. The i-th slide, the j-th text area, and other information may be, for example, the i-th slide, the j-th text area, and the chapter identification information.

(Step S512) The term set obtainer 1321 increments the counter k by 1. The processing returns to step S510.

(Step S513) The term set obtainer 1321 increments the counter j by 1. The processing returns to step S506.

(Step S514) The term set obtainer 1321 increments the counter i by 1. The processing returns to step S502.

The example of the part-of test in step S403 will now be described with reference to the flowchart in FIG. 6.

(Step S601) The reference rate analyzer 1322 obtains the term hierarchy structure from the textbook manager 111.

(Step S602) The reference rate analyzer 1322 substitutes 1 into the counter i.

(Step S603) The reference rate analyzer 1322 determines whether a set of a superordinate term and one or more subordinate terms having an i-th part-of relationship are included in the term hierarchy structure obtained in step S601. When the term set having the i-th part-of relationship is included, the processing advances to step S604. When the term set having the i-th part-of relationship is not included, the processing returns to the superordinate process.

(Step S604) The reference rate analyzer 1322 obtains, from the term hierarchy structure obtained in step S601, the set (a superordinate-subordinate set) of the superordinate term and the one or more subordinate terms having the i-th part-of relationship.

(Step S605) The reference rate analyzer 1322 determines whether the superordinate term in the superordinate-subordinate set obtained in step S604 is included in the term set obtained in step S402. When the superordinate term is included, the processing advances to step S606. When the superordinate term is not included, the processing advances to step S609.

(Step S606) The reference rate analyzer 1322 determines whether all subordinate terms in the superordinate-subordinate set obtained in step S604 are included in the term set obtained in step S402. When all subordinate terms are included, the processing advances to step S607. When not all subordinate terms are included, the processing advances to step S610.

(Step S607) The reference rate analyzer 1322 adds 1 to a variable of part-of (PASS). The variable of part-of (PASS) counts the number of superordinate-subordinate sets with no issues determined in the part-of test. In this example, the default value is 0 for all variables.

(Step S608) The reference rate analyzer 1322 increments the counter i by 1. The processing returns to step S603.

(Step S609) The reference rate analyzer 1322 writes, in a variable of analysis result, that the superordinate term associated with the i-th part-of relationship is not referred to in the slide set. The processing advances to step S612. The variable of analysis result may include the superordinate term.

(Step S610) The reference rate analyzer 1322 obtains one or more subordinate terms not included in the term set obtained in step S402.

(Step S611) The reference rate analyzer 1322 writes, in the variable of analysis result, that the one or more subordinate terms associated with the i-th part-of relationship are not referred to. The variable of analysis result may include the one or more subordinate terms.

(Step S612) The reference rate analyzer 1322 adds 1 to a variable of part-of (FAIL). The processing advances to step S608. The variable of part-of (FAIL) counts the number of superordinate-subordinate sets with issues determined in the part-of test.

The example of the use-for test in step S404 will now be described with reference to the flowchart in FIG. 7.

(Step S701) The reference rate analyzer 1322 obtains the term hierarchy structure from the textbook manager 111.

(Step S702) The reference rate analyzer 1322 substitutes 1 into the counter i.

(Step S703) The reference rate analyzer 1322 determines whether a set (superordinate-subordinate set) of a superordinate term and one or more subordinate terms having an i-th use-for relationship are included in the term hierarchy structure obtained in step S701. When the superordinate-subordinate set is included, the processing advances to step S704. When the superordinate-subordinate set is not included, the processing returns to the superordinate process.

(Step S704) The reference rate analyzer 1322 obtains, from the term hierarchy structure obtained in step S701, the superordinate-subordinate set having the i-th use-for relationship.

(Step S705) The reference rate analyzer 1322 determines whether the superordinate term in the superordinate-subordinate set obtained in step S704 is included in the term set obtained in step S402. When the superordinate term is included, the processing advances to step S706. When the superordinate term is not included, the processing advances to step S713.

(Step S706) The reference rate analyzer 1322 identifies, among the subordinate terms in the superordinate-subordinate set obtained in step S704, subordinate terms included in the term set obtained in step S402 and subordinate terms not included in the term set obtained in step S402.

(Step S707) The reference rate analyzer 1322 obtains the number or ratio of the subordinate terms included in the term set obtained in step S402 among the subordinate terms included in the superordinate-subordinate set obtained in step S704.

(Step S708) The reference rate analyzer 1322 determines whether the number or ratio obtained in step S707 satisfies the indication condition. When the indication condition is satisfied, the processing advances to step S711. When the indication condition is not satisfied, the processing advances to step S709.

(Step S709) The reference rate analyzer 1322 adds 1 to a variable of use-for (PASS). The variable of use-for (PASS) counts the number of superordinate-subordinate sets with no issues determined in the use-for test.

(Step S710) The reference rate analyzer 1322 increments the counter i by 1. The processing returns to step S703.

(Step S711) The reference rate analyzer 1322 obtains one or more subordinate terms not included in the term set obtained in step S402. The reference rate analyzer 1322 writes, in the variable of analysis result, an indication to add the one or more subordinate terms not included. The variable of analysis result may include the one or more subordinate terms.

(Step S712) The reference rate analyzer 1322 adds 1 to a variable of use-for (FAIL). The processing advances to step S710. The variable of use-for (FAIL) counts the number of superordinate-subordinate sets with issues determined in the use-for test.

(Step S713) The reference rate analyzer 1322 writes, in the variable of analysis result, that the superordinate term associated with the i-th use-for relationships is not referred to in the slide set. The processing advances to step S712. The variable of analysis result may include the superordinate term.

The example of the same-as test in step S405 will now be described with reference to the flowchart in FIG. 8.

(Step S801) The reference rate analyzer 1322 obtains the term hierarchy structure from the textbook manager 111.

(Step S802) The reference rate analyzer 1322 substitutes 1 into the counter i.

(Step S803) The reference rate analyzer 1322 determines whether a set of two or more terms having an i-th same-as relationship is included in the term hierarchy structure obtained in step S801. When the term set having the i-th same-as relationship is included, the processing advances to step S804. When the term set having the i-th same-as relationship is not included, the processing returns to the superordinate process.

(Step S804) The reference rate analyzer 1322 obtains, from the term hierarchy structure obtained in step S801, the set of two or more terms having the i-th same-as relationship.

(Step S805) The reference rate analyzer 1322 determines whether any of the two or more terms obtained in step S804 is included in the term set obtained in step S402. When any of the terms is included, the processing advances to step S806. When none of the terms are included, the processing advances to step S808.

(Step S806) The reference rate analyzer 1322 adds 1 to a variable of same-as (PASS). The variable of same-as (PASS) counts the number of term sets with no issues determined in the same-as test.

(Step S807) The reference rate analyzer 1322 increments the counter i by 1. The processing returns to step S803.

(Step S808) The reference rate analyzer 1322 writes, in the variable of analysis result, that any of the two or more terms obtained in step S804 is to be added to the slide set. The variable of analysis result may include any of the two or more terms.

(Step S809) The reference rate analyzer 1322 adds 1 to a variable of same-as (FAIL). The processing advances to step S807.

The example of the is-a-kind-of test in step S406 will now be described with reference to the flowchart in FIG. 9.

(Step S901) The reference rate analyzer 1322 obtains the term hierarchy structure from the textbook manager 111.

(Step S902) The reference rate analyzer 1322 substitutes 1 into the counter i.

(Step S903) The reference rate analyzer 1322 determines whether a set (superordinate-subordinate set) of a superordinate term and one or more subordinate terms having an i-th is-a-kind-of relationship are included in the term hierarchy structure obtained in step S901. When the superordinate-subordinate set is included, the processing advances to step S904. When the superordinate-subordinate set is not included, the processing returns to the superordinate process.

(Step S904) The reference rate analyzer 1322 obtains, from the term hierarchy structure obtained in step S901, the superordinate-subordinate set having the i-th is-a-kind-of relationship.

(Step S905) The reference rate analyzer 1322 determines whether the superordinate term in the superordinate-subordinate set obtained in step S904 is included in the term set obtained in step S402. When the superordinate term is included, the processing advances to step S906. When the superordinate term is not included, the processing advances to step S914.

(Step S906) The reference rate analyzer 1322 obtains, from the term hierarchy structure obtained in step S901, the order-indicative flag associated with the one or more subordinate terms in the superordinate-subordinate set obtained in step S904.

(Step S907) The reference rate analyzer 1322 determines whether all superordinate terms in the superordinate-subordinate set obtained in step S904 are included in the term set obtained in step S402. When all subordinate terms are included, the processing advances to step S908. When not all subordinate terms are included, the processing advances to step S913.

(Step S908) The reference rate analyzer 1322 determines whether the order of one or more subordinate terms in the term set obtained in step S402 matches the order-indicative flag obtained in step S906. When the order matches the order-indicative flag, the processing advances to step S909. When the order does not match the order-indicative flag, the processing advances to step S911.

(Step S909) The reference rate analyzer 1322 adds 1 to a variable of is-a-kind-of (PASS). The variable of is-a-kind-of (PASS) counts the number of superordinate-subordinate sets with no issues determined in the is-a-kind-of test.

(Step S910) The reference rate analyzer 1322 increments the counter i by 1. The processing returns to step S903.

(Step S911) The reference rate analyzer 1322 writes, in the variable of analysis result, information suggesting a change of the order of the subordinate terms. The variable of analysis result may include the subordinate terms.

(Step S912) The reference rate analyzer 1322 adds 1 to a variable of is-a-kind-of (FAIL). The processing advances to step S910. The variable of is-a-kind-of (FAIL) counts the number of superordinate-subordinate sets with issues determined in the is-a-kind-of test.

(Step S913) The reference rate analyzer 1322 obtains one or more subordinate terms not included in the term set obtained in step S402. The reference rate analyzer 1322 writes, in the variable of analysis result, an indication to add the one or more subordinate terms not included. The processing advances to step S912.

(Step S914) The reference rate analyzer 1322 writes, in the variable of analysis result, that the superordinate term is not referred to. The processing advances to step S912. The variable of analysis result may include the superordinate term.

The example of the term variation test in step S407 will now be described with reference to the flowchart in FIG. 10.

(Step S1001) The analyzer 132 obtains the term hierarchy structure from the textbook manager 111.

(Step S1002) The analyzer 132 substitutes 1 into the counter i.

(Step S1003) The analyzer 132 determines whether a set of two or more terms having the i-th same-as relationship is included in the term hierarchy structure obtained in step S1001. When the term set having the i-th same-as relationship is included, the processing advances to step S1004. When the term set having the i-th same-as relationship is not included, the processing returns to the superordinate process.

(Step S1004) The analyzer 132 obtains, from the term hierarchy structure obtained in step S1001, the set of two or more terms having the i-th same-as relationship.

(Step S1005) The analyzer 132 determines whether multiple words among the two or more terms obtained in step S1004 are included in the term set obtained in step S402. When multiple terms are included, the processing advances to step S1006. When multiple terms are not included, the processing advances to step S1010. When multiple terms are included in the slide set, multiple terms having the same-as relationship are included in the slide set.

(Step S1006) The analyzer 132 determines whether the multiple terms are simply used in the same sentence in the slide set. When the terms are simply used in the same sentence, the processing advances to step S1010. When the terms are used in different sentences, the processing advances to step S1007.

(Step S1007) The analyzer 132 writes, in the variable of analysis result, information indicating the term variation for the multiple terms. The variable of analysis result may include the multiple terms.

(Step S1008) The analyzer 132 adds 1 to a variable of term variation (FAIL). The variable of term variation (FAIL) counts the number of term sets with issues determined in the term variation test.

(Step S1009) The analyzer 132 increments the counter i by 1. The processing returns to step S1003.

(Step S1010) The analyzer 132 adds 1 to a variable of term variation (PASS). The variable of term variation (PASS) counts the number of term sets with no issues determined in the term variation test.

The example of the itemization test in step S408 will now be described with reference to the flowchart in FIG. 11.

(Step S1101) The reference order analyzer 1323 detects all text areas with numbered itemizations in the slide set.

(Step S1102) The reference order analyzer 1323 substitutes 1 into the counter i.

(Step S1103) The reference order analyzer 1323 determines whether an i-th text area detected in step S1101 is included. When the i-th text area is included, the processing advances to step S1104. When the i-th text area is not included, the processing returns to the superordinate process.

(Step S1104) The reference order analyzer 1323 obtains, from the slide set, a term set in the i-th text area.

(Step S1105) The reference order analyzer 1323 searches the reference order information or the term hierarchy structure for the term set obtained in step S1104.

(Step S1106) When the term set is included in the reference order information or the term hierarchy structure, the reference order analyzer 1323 advances the processing to step S1107. When the term set is not included, the reference order analyzer 1323 advances the processing to step S1110.

(Step S1107) The reference order analyzer 1323 determines whether the order-indicative flag associated with the term set in the reference order information or the term hierarchy structure is the ordered flag, and whether the order matches the order of the terms in the i-th text area described above. When the above condition is satisfied, the processing advances to step S1108. When the above condition is not satisfied, the processing advances to step S1110.

(Step S1108) The reference order analyzer 1323 adds 1 to a variable of itemization (PASS). The variable of itemization (PASS) counts the number of term sets with no issues determined in the itemization test.

(Step S1109) The reference order analyzer 1323 increments the counter i by 1. The processing returns to step S1103.

(step S1110) The reference order analyzer 1323 writes, in the variable of search result, that the numbered term set is unacceptable itemization. The variable of search result may include the numbered term set.

(Step S1111) The reference order analyzer 1323 adds 1 to a variable of itemization (FAIL). The processing advances to step S1109. The variable of itemization (FAIL) counts the number of term sets with issues determined in the itemization test.

The example of the parallel relationship test in step S409 will now be described with reference to the flowchart in FIG. 12.

(Step S1201) The reference rate analyzer 1322 substitutes 1 into the counter i.

(Step S1202) The reference rate analyzer 1322 determines whether an i-th page is included in the slide set. When the i-th page is included, the processing advances to step S1203. When the i-th page is not included, the processing returns to the superordinate process.

(Step S1203) The reference rate analyzer 1322 substitutes 1 into the counter j.

(Step S1204) The reference rate analyzer 1322 determines whether a j-th text area is included in the i-th page. When the j-th text area is included, the processing advances to step S1205. When the j-th text area is not included, the processing advances to step S1216.

(Step S1205) The reference rate analyzer 1322 determines whether an indent is included in the j-th text in the i-th page. When an indent is included, the processing advances to step 1206. When no indent is included, the processing advances to step S1215.

(Step S1206) The reference rate analyzer 1322 substitutes 1 into the counter k.

(Step S1207) The reference rate analyzer 1322 determines whether two or more terms in the same k-th hierarchy are included at the indent in the j-th text area in the i-th page. When two or more terms in the same hierarchy are included, the processing advances to step S1208. When two or more terms in the same hierarchy are not included, the processing advances to step S1215.

(Step S1208) The reference rate analyzer 1322 obtains, from the j-th text area in the i-th page, the set of two or more terms in the k-th hierarchy at the indent in the j-th text area in the i-th page.

(Step S1209) The reference rate analyzer 1322 searches the term hierarchy structure in the textbook manager 111 for each of the two or more terms obtained in step S1208.

(Step S1210) The reference rate analyzer 1322 determines whether each of the two or more terms obtained in step S1208 is in the same hierarchy as well in the term hierarchy structure included in the textbook manager 111. When the term is in the same hierarchy, the processing advances to step S1211. When the term is not in the same hierarchy, the processing advances to S1213.

(Step S1211) The reference rate analyzer 1322 adds 1 to a variable of parallel relationship (PASS). The variable of parallel relationship (PASS) counts the number of term sets with no issues determined in the parallel relationship test.

(Step S1212) The reference rate analyzer 1322 increments the counter k by 1. The processing returns to step S1207.

(Step S1213) The reference rate analyzer 1322 writes, in the variable of analysis result, that the set of two or more terms has an unacceptable parallel relationship. The variable of search result may include the set of two or more terms.

(Step S1214) The reference rate analyzer 1322 adds 1 to a variable of parallel relationship (FAIL). The processing advances to step S1212. The variable of parallel relationship (FAIL) counts the number of term sets with issues determined in the parallel relationship test.

(Step S1215) The reference rate analyzer 1322 increments the counter j by 1. The processing returns to step S1204.

(Step S1216) The reference rate analyzer 1322 increments the counter i by 1. The processing returns to step S1202.

The example of the hierarchical relationship test in step S410 will now be described with reference to the flowchart in FIG. 13.

(Step S1301) The reference rate analyzer 1322 substitutes 1 into the counter i.

(Step S1302) The reference rate analyzer 1322 determines whether the i-th page is included in the slide set. When the i-th page is included, the processing advances to step S1303. When the i-th page is not included, the processing returns to the superordinate process.

(Step S1303) The reference rate analyzer 1322 substitutes 1 into the counter j.

(Step S1304) The reference rate analyzer 1322 determines whether a j-th text area is included in the i-th page. When the j-th text area is included, the processing advances to step S1305. When the j-th text area is not included, the processing advances to step S1316.

(Step S1305) The reference rate analyzer 1322 determines whether an indent is included in the j-th text area in the i-th page. When an indent is included, the processing advances to step S1306. When no indent is included, the processing advances to step S1315.

(Step S1306) The reference rate analyzer 1322 substitutes 1 into the counter k.

(Step S1307) The reference rate analyzer 1322 determines whether two terms having a k-th hierarchical relationship are included at the indent in the j-th text area in the i-th page. When two terms having the k-th hierarchical relationship are included, the processing advances to step S1308. When two terms having the k-th hierarchical relationship are not included, the processing advances to step S1315.

(Step S1308) The reference rate analyzer 1322 obtains, from the j-th text area in the i-th page, the two terms having the k-th hierarchical relationship at the indent in the j-th text area in the i-th page.

(Step S1309) The reference rate analyzer 1322 searches the term hierarchy structure in the textbook manager 111 for each of the two terms obtained in step S1308.

(Step S1310) The reference rate analyzer 1322 determines whether the two terms obtained in step S1308 have a hierarchical relationship as well in the term hierarchy structure included in the textbook manager 111. When the terms have a hierarchical relationship, the processing advances to step S1311. When the terms have no hierarchical relationship, the processing advances to S1313.

(Step S1311) The reference rate analyzer 1322 adds 1 to a variable of hierarchical relationship (PASS). The variable of hierarchical relationship (PASS) counts the number of term sets with no issues determined in the hierarchical relationship test.

(Step S1312) The reference rate analyzer 1322 increments the counter k by 1. The processing returns to step S1307.

(Step S1313) The reference rate analyzer 1322 writes, in the variable of analysis result, that the set of two terms has an unacceptable hierarchical relationship. The variable of search result may include the set of two terms.

(Step S1314) The reference rate analyzer 1322 adds 1 to a variable of hierarchical relationship (FAIL). The processing advances to step S1312. The variable of hierarchical relationship (FAIL) counts the number of term sets with issues determined in the hierarchical relationship test.

(Step S1315) The reference rate analyzer 1322 increments the counter j by 1. The processing returns to step S1304.

(Step S1316) The reference rate analyzer 1322 increments the counter i by 1. The processing returns to step S1302.

The example of the comprehensiveness test in step S411 will now be described with reference to the flowchart in FIG. 14.

(Step S1401) The reference rate analyzer 1322 substitutes 1 into the counter i.

(Step S1402) The reference rate analyzer 1322 determines whether an i-th page is included in the slide set. When the i-th page is included, the processing advances to step S1403. When the i-th page is not included, the processing returns to the superordinate process.

(Step S1403) The reference rate analyzer 1322 substitutes 1 into the counter j.

(Step S1404) The reference rate analyzer 1322 determines whether a j-th text area is included in the i-th page. When the j-th text area is included, the processing advances to step S1405. When the j-th text area is not included, the processing advances to step S1416.

(Step S1405) The reference rate analyzer 1322 determines whether an indent is included in the j-th text area in the i-th page. When an indent is included, the processing advances to step S1406. When no indent is included, the processing advances to step S1415.

(Step S1406) The reference rate analyzer 1322 substitutes 1 into the counter k.

(Step S1407) The reference rate analyzer 1322 determines whether two or more terms having a k-th hierarchical relationship are included at the indent in the j-th text area in the i-th page. When two or more terms having the k-th hierarchical relationship are included, the processing advances to step S1408. When two or more terms having the k-th hierarchical relationship are not included, the processing advances to step S1416.

(Step S1408) The reference rate analyzer 1322 obtains, from the j-th text area in the i-th page, a single superordinate term among the two or more terms having the k-th hierarchical relationship at the indent in the j-th text area in the i-th page.

(Step S1409) The reference rate analyzer 1322 obtains, from the j-th text area in the i-th page, one or more subordinate terms among the two or more terms having the k-th hierarchical relationship at the indent in the j-th text area in the i-th page.

(Step S1410) The reference rate analyzer 1322 obtains, from the term hierarchy structure in the textbook manager 111, one or more subordinate terms subordinate to the superordinate term obtained in step S1408.

(Step S1411) The reference rate analyzer 1322 determines whether all subordinate terms obtained in step S1410 are included in the subordinate terms obtained in step S1409. When all subordinate terms are included, the processing advances to step S1412. When not all subordinate terms are included, the processing advances to step S1414.

(Step S1412) The reference rate analyzer 1322 adds 1 to a variable of comprehensiveness (PASS). The variable of comprehensiveness (PASS) counts the number of term sets with no issues determined in the comprehensiveness test.

(Step S1413) The reference rate analyzer 1322 increments the counter k by 1. The processing returns to step S1407.

(Step S1414) The reference rate analyzer 1322 writes, in the variable of analysis result, that subordinate terms not included are not referred to as terms subordinate to the superordinate term. The variable of analysis result may include the subordinate terms not included.

(Step S1415) The reference rate analyzer 1322 adds 1 to a variable of comprehensiveness (FAIL). The processing advances to step S1413. The variable of comprehensiveness (FAIL) counts the number of term sets with issues determined in the comprehensiveness test.

(Step S1416) The reference rate analyzer 1322 increments the counter j by 1. The processing returns to step S1404.

(Step S1417) The reference rate analyzer 1322 increments the counter i by 1. The processing returns to step S1402.

The example of the conformity test in step S412 will now be described with reference to the flowchart in FIG. 15.

(Step S1501) The reference rate analyzer 1322 obtains the term set obtained in step S402.

(Step S1502) The reference rate analyzer 1322 substitutes 1 into the counter i.

(Step S1503) The reference rate analyzer 1322 determines whether an i-th term is included in the slide set obtained in step S1501. When the i-th term is included, the processing advances to step S1504. When the i-th term is not included, the processing returns to the superordinate process. For the same terms, the i-th term is a term used first in the slide set.

(Step S1504) The reference rate analyzer 1322 obtains the i-th term and the chapter identification information associated with the i-th term. The chapter identification information is the chapter identification information in the slide.

(Step S1505) The reference rate analyzer 1322 searches the textbook in the textbook manager 111 using the i-th term as a key.

(Step S1506) The reference rate analyzer 1322 obtains, from the textbook, the chapter identification information identifying a chapter in which the i-th term is used first. The chapter identification information is the chapter identification information in the textbook.

(Step S1507) The reference rate analyzer 1322 determines whether an inconformity condition of the chapter identification information in the slide<the chapter identification information in the textbook is satisfied. When the inconformity condition is satisfied, the processing advances to step S1508. When the inconformity condition is not satisfied, the processing advances to step S1511.

(Step S1508) The reference rate analyzer 1322 writes, in the variable of analysis result, that the learning sequence of the term is unconformable. The variable of analysis result may include the term.

(Step S1509) The reference rate analyzer 1322 adds 1 to a variable of conformity (FAIL). The variable of conformity (FAIL) counts the number of terms with issues determined in the conformity test.

(Step S1510) The reference rate analyzer 1322 increments the counter i by 1. The processing returns to step S1503.

(Step S1511) The reference rate analyzer 1322 adds 1 to a variable of conformity (PASS). The processing advances to step S1510. The variable of conformity (PASS) counts the number of terms with no issues determined in the conformity test.

The example of the text volume test in step S413 will now be described with reference to the flowchart in FIG. 16.

(Step S1601) The reference rate analyzer 1322 substitutes 1 into the counter i.

(Step S1602) The reference rate analyzer 1322 determines whether an i-th slide is included in the slide set in the slide manager 112. When the i-th slide is included, the processing advances to step S1603. When the i-th slide is not included, the processing returns to the superordinate process.

(Step S1603) The reference rate analyzer 1322 substitutes 1 into the counter j.

(Step S1604) The reference rate analyzer 1322 determines whether a j-th text volume test unit is included in the i-th slide. When the j-th text volume test unit is included, the processing advances to step S1605. When the j-th text volume test unit is not included, the processing advances to step S1612.

The text volume test unit is used to determine whether a text volume is acceptable. Examples of the text volume test unit include, but are not limited to, a single page, a single text area, a single sentence, and a single item in an itemization.

(Step S1605) The reference rate analyzer 1322 obtains a text in the j-th text volume test unit in the i-th slide.

(Step S1606) The reference rate analyzer 1322 obtains the text volume of the text obtained in step S1605. The text volume is, for example, the number of characters.

(Step S1607) The reference rate analyzer 1322 determines whether the text volume>a threshold. When the text volume>the threshold is satisfied, the processing advances to step S1608. When the text volume>the threshold is not satisfied, the processing advances to step S1611.

(Step S1608) The reference rate analyzer 1322 associates the text obtained in step S1605 with the j-th text volume test unit in the i-th slide and temporarily stores the text into the buffer (not shown). The reference rate analyzer 1322 also obtains a test result indicating a high text volume for the text volume test unit. The analysis result may include the text volume test unit.

(Step S1609) The reference rate analyzer 1322 adds 1 to a variable of text volume (FAIL). The variable of text volume (FAIL) counts the number of texts determined as having an unacceptable text volume in the text volume test.

(Step S1610) The reference rate analyzer 1322 increments the counter j by 1. The processing returns to step S1604.

(Step S1611) The reference rate analyzer 1322 adds 1 to a variable of text volume (PASS). The processing advances to step S1610. The variable of text volume (PASS) counts the number of texts not determined as having an unacceptable text volume in the text volume test.

(Step S1612) The reference rate analyzer 1322 increments the counter i by 1. The processing returns to step S1602.

The example of the sentence ending form test in step S414 will now be described with reference to the flowchart in FIG. 17.

(Step S1701) The reference rate analyzer 1322 substitutes 1 into the counter i.

(Step S1702) The reference rate analyzer 1322 determines whether an i-th slide is included in the slide set in the slide manager 112. When the i-th slide is included, the processing advances to step S1703. When the i-th slide is not included, the processing returns to the superordinate process.

(Step S1703) The reference rate analyzer 1322 substitutes 1 into the counter j.

(Step S1704) The reference rate analyzer 1322 determines whether a j-th sentence is included in the i-th slide. When the j-th sentence is included, the processing advances to step S1705. When the j-th sentence is not included, the processing advances to step S1712.

(Step S1705) The reference rate analyzer 1322 obtains the j-th sentence in the i-th slide.

(Step S1706) The reference rate analyzer 1322 obtains the sentence ending form identifier of the sentence obtained in step S1705. Examples of the sentence ending form identifier include the plain form and the polite form.

(Step S1707) The reference rate analyzer 1322 determines whether the sentence obtained in step S1705 ends with a nominal. When the sentence ends with a nominal, the processing advances to step S1708. When the sentence does not end with a nominal, the processing advances to step S1711.

(Step S1708) The reference rate analyzer 1322 determines whether the sentence ending form identifier obtained in step S1706 matches a predetermined sentence ending form identifier. When the two identifiers match, the processing advances to step S1712. When the two identifiers do not match, the processing advances to step S1709.

(Step S1709) The reference rate analyzer 1322 temporarily stores the j-th sentence into the buffer (not shown). The reference rate analyzer 1322 obtains a test result indicating an unacceptable sentence ending form. The analysis result may include the j-th sentence.

(Step S1710) The reference rate analyzer 1322 adds 1 to a variable of sentence ending form (FAIL). The variable of sentence ending form (FAIL) counts the number of sentences determined unacceptable in the sentence ending form test.

(Step S1711) The reference rate analyzer 1322 increments the counter j by 1. The processing returns to step S1704.

(Step S1712) The reference rate analyzer 1322 adds 1 to a variable of sentence ending form (PASS). The processing advances to step S1711. The variable of sentence ending form (PASS) counts the number of sentences not determined unacceptable in the sentence ending form test.

(Step S1713) The reference rate analyzer 1322 increments the counter i by 1. The processing returns to step S1702.

The example of the automatic correction process in step S415 will now be described with reference to the flowchart in FIG. 18.

(Step S1801) The corrector 134 substitutes 1 into the counter i.

(Step S1802) The corrector 134 detects an i-th term set determined as term variation (FAIL) in the term variation test. When the i-th term set is detected, the processing advances to step S1803. When the i-th term set is not detected, the processing returns to the superordinate process.

(Step S1803) The corrector 134 obtains the i-th term set.

(Step S1804) The corrector 134 substitutes 1 into the counter j.

(Step S1805) The corrector 134 determines whether a j-th term is included in the term set obtained in step S1803. When the j-th term is included, the processing advances to step S1806. When the j-th term is not included, the processing advances to step S1808.

(Step S1806) The corrector 134 obtains the use count of the j-th term in the slide set.

(Step S1807) The corrector 134 increments the counter j by 1. The processing returns to step S1805.

(Step S1808) The corrector 134 obtains, using the use count of each term obtained in step S1806, a representative term with the largest use count.

(Step S1809) The corrector 134 substitutes 1 into the counter k.

(Step S1810) The corrector 134 determines whether a k-th term other than the representative term is included in the term set obtained in step S1803. When the k-th term is included, the processing advances to step S1811. When the k-th term is not included, the processing advances to step S1813.

(Step S1811) The corrector 134 replaces all k-th terms used in the slide set with the representative term.

(Step S1812) The corrector 134 increments the counter k by 1. The processing returns to step S1810.

(Step S1813) The corrector 134 increments the counter i by 1. The processing returns to step S1802.

The example of the suggestion obtaining process in step S416 will now be described with reference to the flowchart in FIG. 19.

(Step S1901) The suggestion obtainer 133 substitutes 1 into the counter i.

(Step S1902) The suggestion obtainer 133 detects an i-th text determined as text volume (FAIL) in the text volume test. When the i-th text is detected, the processing advances to step S1903. When the i-th text is not detected, the processing returns to the superordinate process.

(Step S1903) The suggestion obtainer 133 obtains the i-th text determined as text volume (FAIL) from the buffer (not shown).

(Step S1904) The suggestion obtainer 133 divides the text obtained in step S1903 into two or more sentences and obtains the divided sentences. The resultant sentences are referred to as the divided sentences.

(Step S1905) The suggestion obtainer 133 summarizes the text obtained in step S1903 and obtains the summarized text. The resultant text is referred to as the summarized text.

(Step S1906) The suggestion obtainer 133 stores the divided sentences obtained in step S1904 and the summarized text obtained in step S1905 into the buffer (not shown) in a manner associated with the i-th text.

(Step S1907) The suggestion obtainer 133 increments the counter i by 1. The processing returns to step S1902.

The example of the evaluation process in step S423 will now be described with reference to the flowchart in FIG. 20.

(Step S2001) The evaluator 135 substitutes 1 into the counter i.

(Step S2002) The evaluator 135 detects an i-th test that has been performed. When the i-th test is detected, the processing advances to step S2003. When the i-th test is not detected, the processing advances to step S2006.

(Step S2003) The evaluator 135 obtains the number of PASSes and the number of FAILs in the i-th test. The number of PASSes is, for example, the values of the above variables including (PASS), such as the variable of part-of (PASS) and the variable of use-for (PASS). The number of FAILs is, for example, the values of the above variables including (FAIL), such as the variable of part-of (FAIL) and the variable of use-for (FAIL).

(Step S2004) The evaluator 135 obtains the evaluation value for the i-th test using one or both of the number of PASSes and the number of FAILs. The evaluation value for the i-th test is based on, for example, the ratio of the number of PASSes, the ratio of the number of FAILs, or the number of FAILs. The evaluation value is typically lower when the number of FAILs is larger. The evaluation value is typically higher when the number of PASSes is larger.

(Step S2005) The evaluator 135 increments the counter i by 1. The processing returns to step S2002.

(Step S2006) The evaluator 135 obtains the overall evaluation value for the slide set using the evaluation values for each of the two or more tests obtained in step S2004. The processing returns to the superordinate process. The overall evaluation value is typically higher when the evaluation value for each test is higher.

A specific operation example of the slide analysis device 1 according to the present embodiment will now be described.

The textbook manager 111 in the slide analysis device 1 stores a textbook (electronic data of the textbook) for a subject of Algorithms and Data Structures.

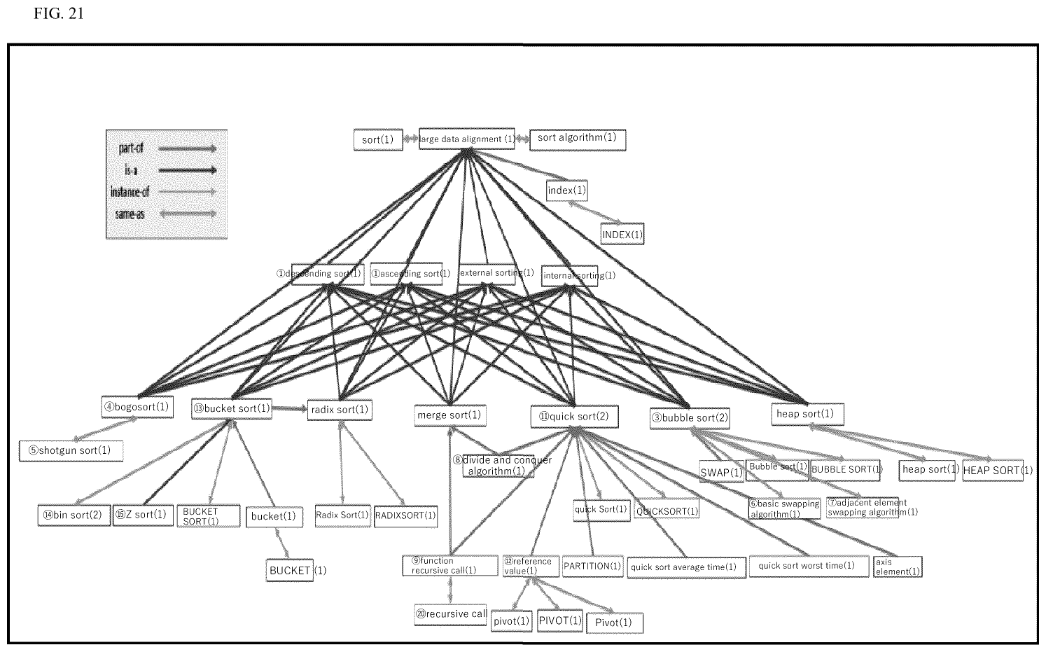

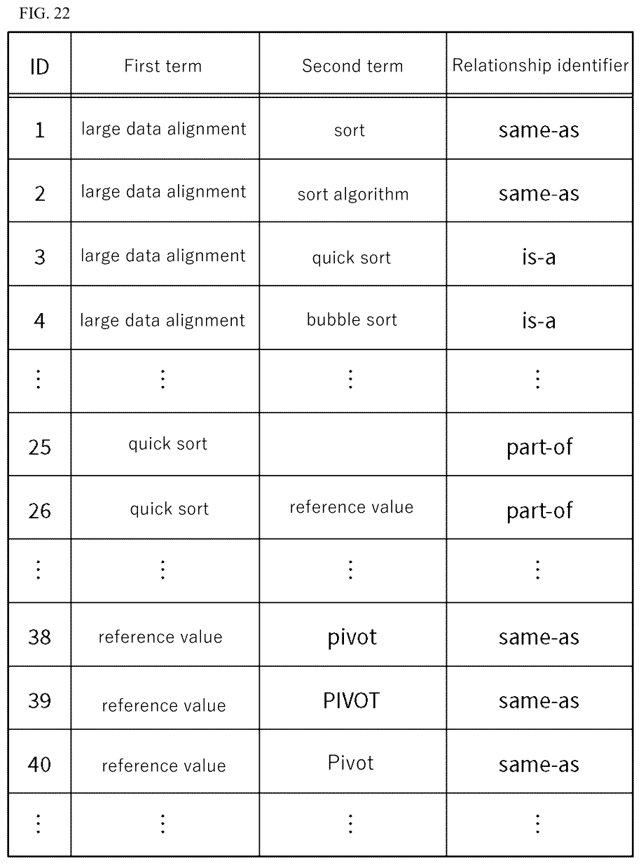

The textbook manager 111 stores the term hierarchy structure in FIG. 21 created based on the textbook. The term hierarchy structure in FIG. 21 is based on, for example, a term hierarchy management table in FIG. 22. The term hierarchy management table includes two or more records each including an ID, a first term, a second term, and the relationship identifier. The ID identifies each record. The first term and the second term are terms. When the relationship identifier indicates a hierarchical relationship (e.g., is-a, part-of, use-for, instance-of, is-a-kind-of, refer-to, and is-an-example-of), the first term is a superordinate term, and the second term is a subordinate term. When the relationship identifier indicates a nonhierarchical relationship (e.g., same-as), the first term and the second term are terms parallel to each other. Although not shown in FIG. 22, each term is associated with the chapter identification information identifying the chapter in which the term is used.

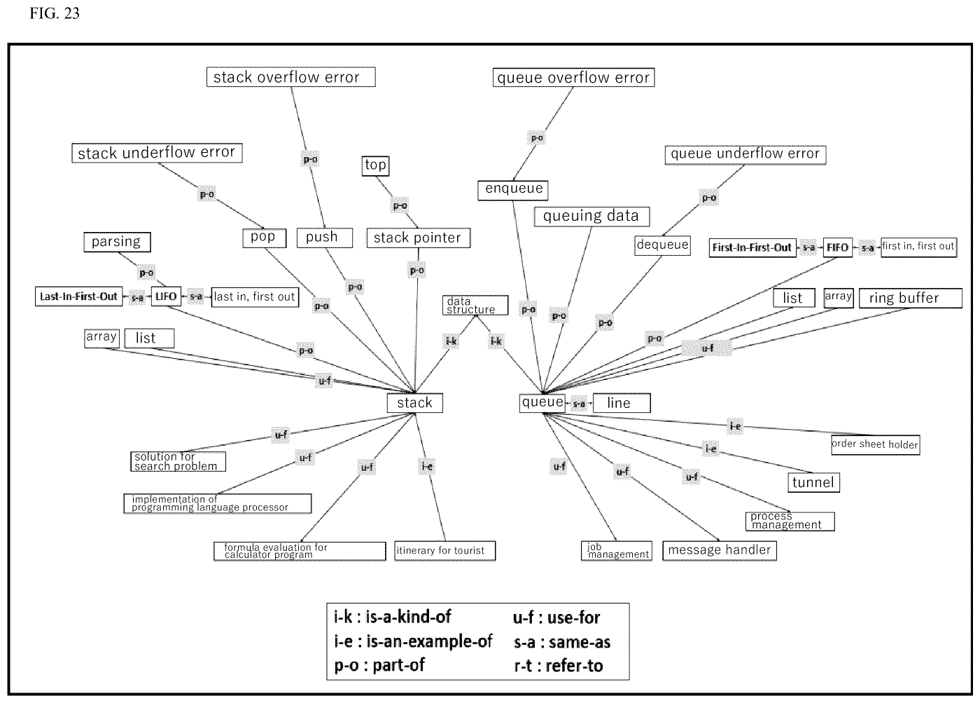

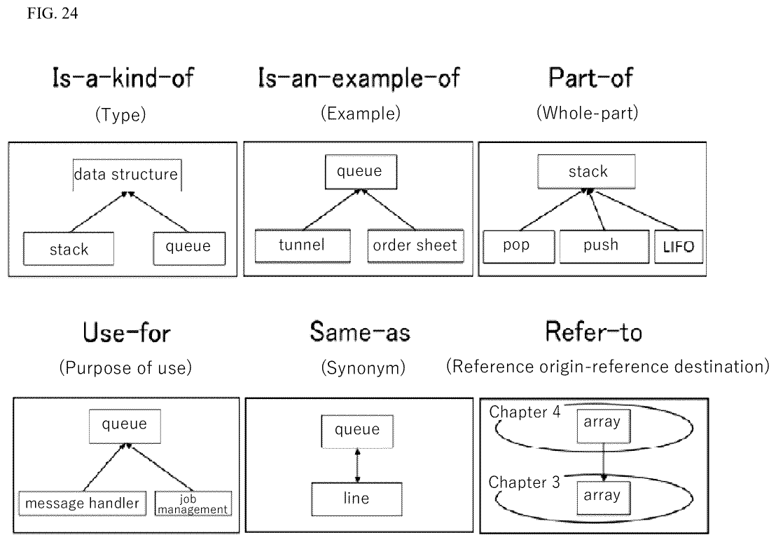

The textbook manager 111 may store the term hierarchy structure in FIG. 23 created based on the textbook. In FIG. 23, the relationship identifiers of is-a-kind-of, is-an-example-of part-of, use-for, same-as, and refer-to are managed. FIG. 24 shows example terms associated with one another with these relationship identifiers. The term hierarchy structure in FIG. 23 is managed based on, for example, the term hierarchy management table in FIG. 22 as well.

The textbook manager 111 in the slide analysis device 1 also stores the reference order information created based on the textbook. The reference order information is, for example, “list, stack.” The reference order information indicates that “list” precedes “stack.” With “list” and “stack” having the is-a-kind-of relationship and “list” used for implementing “stack,” “list” is to be referred to prior to “stack.”

Further, the slide manager 112 stores the slide set generated by the generator 131 in the slide analysis device 1 based on the textbook for the subject of Algorithms and Data Structures.

In the above example, the slide manager 112 performs tests on the slide set in the slide manager 112. The tests refer to the processes described with reference to the flowcharts in FIGS. 4 to 20.

Through the tests, the analyzer 132 detects the term variation shown in a slide 301 in FIG. 3, and the corrector 134 corrects the term variation by correcting “pivot” to “reference value” as shown in a slide 302 in FIG. 3. The analysis output unit 141 then outputs the slide 301 in FIG. 3, and the correction output unit 142 outputs the slide 302 in FIG. 3.

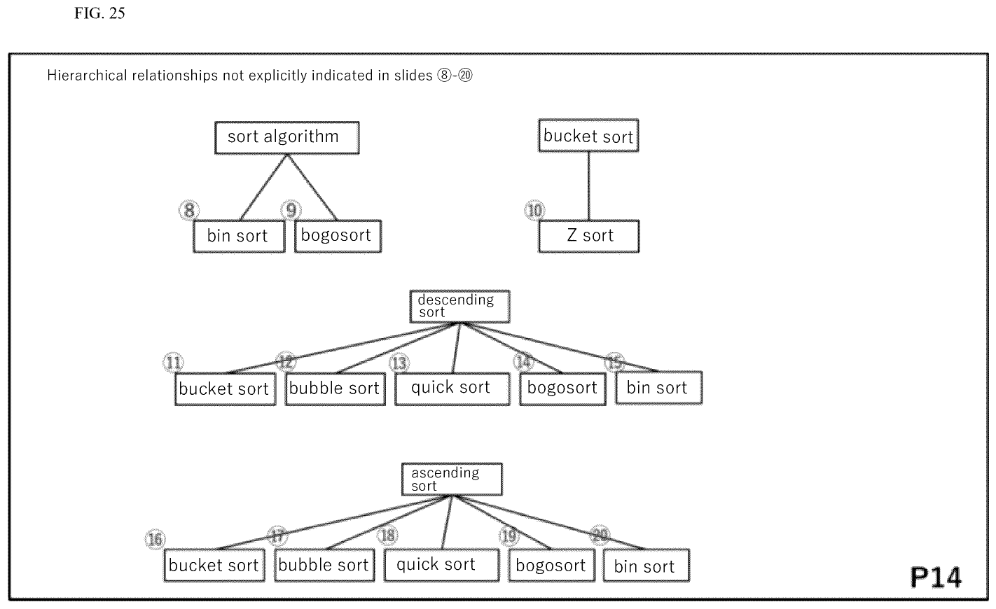

The analyzer 132 also performs the hierarchical relationship test described above to detect the hierarchical relationship between terms that is not explicitly indicated in the slide set. The analysis output unit 141 then outputs, for example, a test result screen shown in FIG. 25. The screen shows sets of terms with the hierarchical relationships that are not explicitly shown in the slide set.

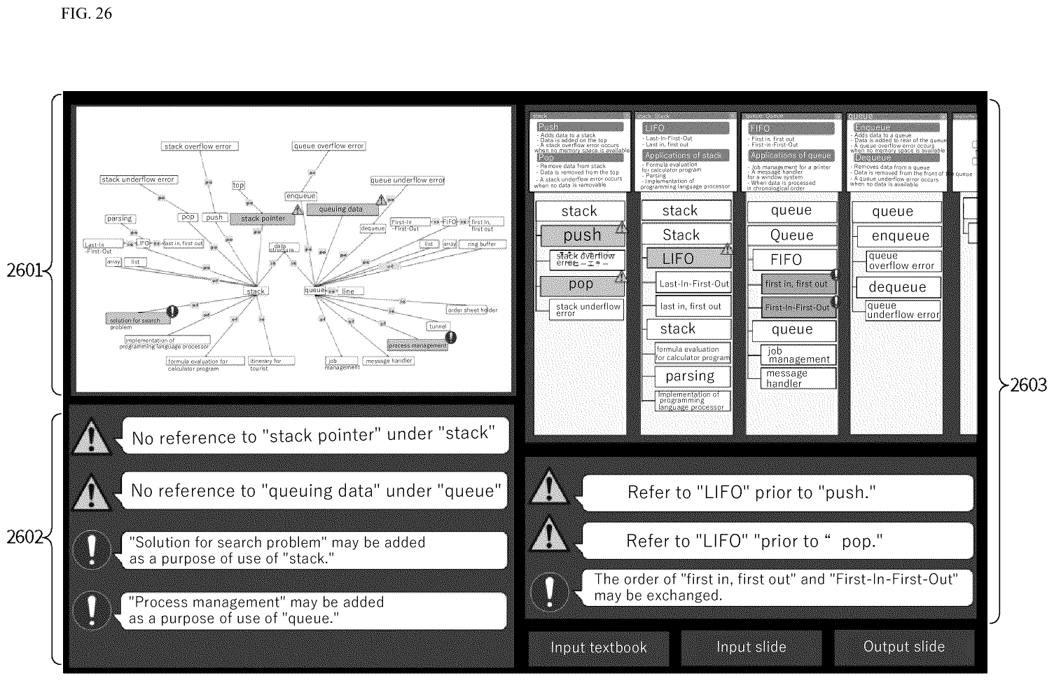

The analyzer 132 performs the various tests described above, and the output unit 14 outputs the test results shown in FIG. 26. A section 2601 in FIG. 26 shows edit suggestions detected by the reference rate analyzer 1322 together with a concept hierarchy. A section 2602 in FIG. 26 shows comments for the respective edit suggestions. A section 2603 in FIG. 26 shows, together with topics in the slides, edit suggestions based on the detection results of the reference order detected by the reference order analyzer 1323.

In FIG. 26, a triangular mark is an indication that the edit suggestion is to be edited. In FIG. 26, a circular mark is a suggestion that the edit suggestion may be edited.

As described above, the structure according to the present embodiment can assist in checking information on the slides by analyzing the slides based on the textbook information.

The structure according to the present embodiment can obtain the analysis results about the reference rate for the slides.

The structure according to the present embodiment can obtain the analysis results about the reference order in the slides.

The structure according to the present embodiment allows appropriate checking of information on the slides.

The structure according to the present embodiment can assist in providing text with an acceptable text volume for each slide.

The structure according to the present embodiment can detect an inconsistent sentence ending form in the slides.

The structure according to the present embodiment can provide two or more correction suggestions for the slides.

The structure according to the present embodiment can correct the slides automatically.

The processes in the present embodiment may be performed using software. The software may be distributed by, for example, software download. The software may be distributed by storing the software into a recording medium such as a compact disk-read only memory (CD-ROM). This applies to other embodiments described herein. The software implementing the slide analysis device 1 according to the present embodiment is a program described below. Specifically, the program is a program executable by a computer that accesses a textbook manager storing textbook information based on a textbook and a slide manager storing a slide set including two or more slides. The program causes the computer to function as an analyzer and an analysis output unit. The analyzer analyzes the slide set based on the textbook information and obtains an analysis result. The analysis output unit outputs the analysis result obtained by the analyzer.

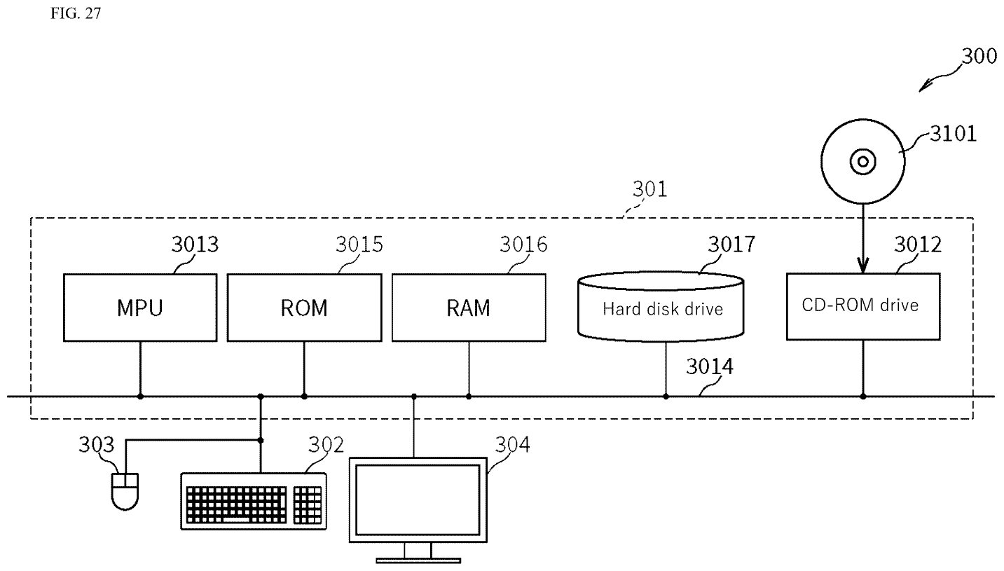

FIG. 27 is a block diagram of a computer system 300 that executes the program described herein to implement the slide analysis device 1 according to the various embodiments described above.

In FIG. 27, the computer system 300 includes a computer 301 including a CD-ROM drive 3012, a keyboard 302, a mouse 303, and a monitor 304.

In FIG. 27, the computer 301 includes, in addition to the CD-ROM drive 3012, an MPU 3013, a bus 3014 connected to the CD-ROM drive 3012 and other components, a ROM 3015 for storing programs such as a boot-up program, a RAM 3016 connected to the MPU 3013 for temporarily storing instructions for application programs and providing a temporary storage space, and a hard disk drive 3017 for storing the application programs, system programs, and data. Although not shown in the figure, the computer 301 may further include a network card for providing connection to a local area network (LAN).

The program for causing the computer system 300 to implement the functions of the slide analysis device 1 according to the above embodiments may be stored in a CD-ROM 3101, inserted into the CD-ROM drive 3012, and transferred to the hard disk drive 3017. The program may instead be transmitted to the computer 301 through a network (not shown) and stored into the hard disk drive 3017. The program is loaded into the RAM 3016 for execution. The program may be loaded from the CD-ROM 3101 or through a network directly.

The program may not include an operating system (OS) or a third-party program that causes the computer 301 to implement the functions of the slide analysis device 1 according to the above embodiments. The program may simply include an instruction to call an appropriate function (module) in a controlled manner to obtain an intended result. The operation of the computer system 300 is known and will not be described in detail.

The above program does not include processes performed by hardware in, for example, transmitting information or receiving information. For example, the program does not include, in transmitting information, processes performed by, for example, a modem or an interface card (processes performed solely by hardware).

The program may be executed by a single computer or by multiple computers. In other words, the processing may be centralized or distributed.

In each of the above embodiments, two or more communicators in a single device may be physically implemented with a single medium.

In each of the above embodiments, each process may be performed through centralized processing with a single device or through distributed processing with multiple devices.

The present invention is not limited to the above embodiments, but may be modified variously within the scope of the present invention.

As described above, the slide analysis device 1 according to the embodiments of the present invention can assist in checking information on the slides, and is useful as a server that analyzes the slides.

### REFERENCE SIGNS LIST

1 slide analysis device
11 storage
12 receiver
13 processor
14 output unit
111 textbook manager
112 slide manager
131 generator
132 analyzer
133 suggestion obtainer
134 corrector
135 evaluator
141 analysis output unit
142 correction output unit
143 suggestion output unit
144 evaluation output unit
1321 term set obtainer
1322 reference rate analyzer
1323 reference order analyzer

1. A non-transitory computer-readable storage medium storing program executable by a computer configured to access a textbook manager storing textbook information based on a textbook and a slide manager storing a slide set including two or more slides, the program causing the computer to function as:
an analyzer configured to analyze the slide set based on the textbook information and obtain an analysis result; and
an analysis output unit configured to output the analysis result obtained by the analyzer.

2. The non-transitory computer-readable storage medium according to claim 1, wherein
the textbook information includes a term hierarchy structure including two or more terms and one or more relationship identifiers each identifying a conceptual relationship between the two or more terms, and
the analyzer includes
a term set obtainer configured to obtain a term set from each of the two or more slides in the slide set, and
a reference rate analyzer configured to obtain, from the textbook information, a relationship identifier for two or more terms included in the term set, and obtain, using the term set and the relationship identifier for the two or more terms, an analysis result about a reference rate for the two or more terms.

3. The non-transitory computer-readable storage medium according to claim 2, wherein
the one or more relationship identifiers include a part-of relationship identifier, a use-for relationship identifier, or a same-as relationship identifier,
the term hierarchy structure includes a superordinate term indicating a superordinate concept and two or more subordinate terms indicating subordinate concepts associated with the part-of relationship identifier, a superordinate term and two or more subordinate terms associated with the use-for relationship identifier, or two or more terms associated with the same-as relationship identifier, and
the reference rate analyzer performs
a part-of test to determine whether the term set includes the superordinate term associated with the part-of relationship identifier and all the two or more subordinate terms associated with the part-of relationship identifier, and obtain, when one or more subordinate terms of the two or more subordinate terms are not included, an analysis result indicating that the one or more subordinate terms are to be added,
a use-for test to obtain, when the term set includes the superordinate term associated with the use-for relationship identifier, a number or a ratio of subordinate terms included in the term set among the one or more terms associated with the use-for relationship identifier, and obtain, when the number or the ratio of subordinate terms is smaller than a predetermined value and satisfies an indication condition, an analysis result indicating that a subordinate term not being included in the term set is to be added, or
a same-as test to determine whether the term set includes one or more terms of the two or more terms associated with the same-as relationship identifier, and obtain, when none of the two or more terms are included, an analysis result indicating that one or more terms of the two or more terms are to be added.

4. The non-transitory computer-readable storage medium according to claim 1, wherein
the textbook information includes two or more terms and reference order information identifying a reference order in which the two or more terms are referred to, and
the analyzer includes
a term set obtainer configured to obtain, from each of the two or more slides in the slide set, a term set including two or more terms for which a use order in the slide is identifiable, and
a reference order analyzer configured to obtain, using the term set and the reference order information, an analysis result about the reference order of the two or more terms in the term set.

5. The non-transitory computer-readable storage medium according to claim 2, wherein
the one or more relationship identifiers include an is-a-kind-of relationship identifier,
each of two or more subordinate terms associated with the is-a-kind-of relationship identifier is associated with an order-indicative flag being an ordered flag identifying the term as being ordered or an unordered flag identifying the term as being unordered, and
the reference order analyzer performs an is-a-kind-of test to determine, using the reference order information, whether the term set includes a superordinate term associated with the is-a-kind-of relationship identifier and whether the term set includes two or more subordinate terms associated with the ordered flag among the two or more subordinate terms associated with the is-a-kind-of relationship identifier in an order of the two or more subordinate terms, and obtain, when the two or more subordinate terms are not included in the order, an analysis result indicating that the order is to be changed.

6. The non-transitory computer-readable storage medium according to claim 1, wherein
the textbook information is an ordered term system including a term hierarchy structure and reference order information, the term hierarchy structure includes two or more terms and one or more relationship identifiers each identifying a conceptual relationship between the two or more terms, and the reference order information identifies a reference order in which the two or more terms are referred to, and
the analyzer includes
a term set obtainer configured to obtain, from each of the two or more slides in the slide set, a term set including two or more terms for which a use order in the slide is identifiable,
a reference rate analyzer configured to obtain, from the textbook information, a relationship identifier for the two or more terms included in the terms set, and obtain, using the term set and the relationship identifier for the two or more terms, an analysis result about a reference rate for the two or more terms, and
a reference order analyzer configured to obtain, using the term set and the reference order information, an analysis result about the reference order of the two or more terms in the term set.

7. The non-transitory computer-readable storage medium according to claim 1, wherein
the analyzer includes a term set obtainer configured to obtain, from each of the two or more slides in the slide set, a term set, and
the analyzer performs
a term variation test to obtain an analysis result indicating a term variation when determining, using a term hierarchy structure in the textbook information, that a plurality of terms of two or more terms associated with a same-as relationship identifier are included in the term set in the slide set,
an itemization test to obtain an analysis result indicating an unacceptable itemization when determining, using reference order information in the textbook information, that a term without a reference order is presented in a numbered paragraph in the slide set,
a parallel relationship test to obtain an analysis result indicating an unacceptable parallel relationship when determining, using the term hierarchy structure in the textbook information and indent information of a slide in the slide set, that two or more terms included in a same hierarchy in an indent do not have a parallel relationship,
a hierarchical relationship test to obtain an analysis result indicating an unacceptable hierarchical relationship when obtaining, using the term hierarchy structure in the textbook information and the indent information of a slide in the slide set, two or more terms having a hierarchical relationship in the slide and determining that the hierarchical relationship between the two or more terms does not match a hierarchical relationship between same two or more terms in the term hierarchy structure,
a comprehensiveness test to obtain an analysis result indicating no comprehensiveness for subordinate terms when obtaining, using the term hierarchy structure in the textbook information, one or more terms subordinate to a term in the slide set and determining that at least one of the one or more subordinate terms is not used in the slide set, or
a conformity test to obtain, using chapter identification information identifying a chapter of the textbook in which a term is used, the chapter identification information for each term used in a slide in the slide set, and obtain, when the slide is associated with chapter identification information identifying an earlier chapter than a chapter identified by the chapter identification information for each term, an analysis result indicating that a learning sequence is unconformable.

8. The non-transitory computer-readable storage medium according to claim 1, wherein the analyzer performs a text volume test to obtain a text volume of a part of or all of a slide in the slide set and obtain, when the text volume is greater than or equal to a threshold, an analysis result indicating an unacceptable text volume.

9. The non-transitory computer-readable storage medium according to claim 1, wherein
the analyzer performs a sentence ending form test to obtain two or more sentences from each slide in the slide set, obtain a sentence ending form identifier of each of the two or more sentences, and obtain an analysis result indicating an inconsistent sentence ending form when the sentence ending form identifier of each of the two or more sentences excluding a sentence ending with a nominal differs from a predetermined sentence ending form identifier or when two or more types of sentence ending form identifiers are obtained from the two or more sentences excluding a sentence ending with a nominal.

10. The non-transitory computer-readable storage medium according to claim 1, the program further causing the computer to function as:
a corrector configured to correct the slide set based on the analysis result obtained by the analyzer.

11. The non-transitory computer-readable storage medium according to claim 1, the program further causing the computer to function as:
a suggestion obtainer configured to obtain two or more correction suggestions for a slide based on the analysis result obtained by the analyzer, the analysis result including information about a slide edit suggestion, and
a suggestion output unit configured to output the two or more correction suggestions.

12. A slide analysis device, comprising:
a textbook manager configured to store textbook information based on a textbook;
a slide manager configured to store a slide set including two or more slides;
an analyzer configured to analyze the slide set based on the textbook information and obtain an analysis result; and
an analysis output unit configured to output the analysis result obtained by the analyzer.

13. A slide analysis method implementable with a textbook manager configured to store textbook information based on a textbook, a slide manager configured to store a slide set including two or more slides, an analyzer, and an analysis output unit, the method comprising:
analyzing, with the analyzer, the slide set based on the textbook information and obtaining an analysis result; and
outputting, with the analysis output unit, the analysis result obtained by the analyzer.
